(19) United States
(12) Patent Application Publication
(10) Pub. No.: US 2007/0088108 A1
(43) Pub. Date: Apr. 19, 2007

(54) Stabilization of polyolefins with liquid cyclic phosphites

(76) Inventors: Samuel Evans, Marly (CH); Sai P. Shum, Pleasantville, NY (US); Roswell E. King, Pleasantville, NY (US); Walid Al-Akhdar, Mobile, AL (US)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(21) Appl. No.: 11/545,844

(22) Filed: Oct. 11, 2006

Related U.S. Application Data
(60) Provisional application No. 60/726,310, filed on Oct. 13, 2005.

(51) Int. Cl. C08K 5/5399; C09K 15/32

(52) U.S. Cl. 524/116; 252/400.2

(57) ABSTRACT

The present invention discloses liquid cyclic phosphites of for example the formula 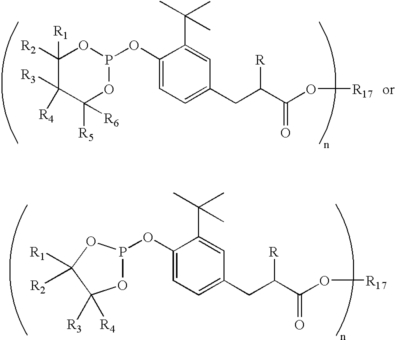
where n is 1 or 2; when n is 1, R₁₇ is straight or branched chain alkyl of 1 to 18 carbon atoms, when n is 2, R₁₇ is —CₜH₂ₜ— or —CH₂CH₂-T₃-CH₂CH₂— where T₃ is —S— or >N—R₂₂ where R₂₂ is straight or branched chain alkyl of 1 to 12 carbon atoms and t is an integer of from 2 to 6, R₁, R₂, R₃, R₄, R₅ and R₆ are independently hydrogen, methyl, ethyl, i-propyl, n-propyl, n-butyl, sec-butyl or t-butyl and R is hydrogen. Also disclosed is a stabilized composition comprising polyolefin and a present liquid cyclic phosphite and a process for the stabilization of polyolefin by incorporating therein or applying thereto a present liquid cyclic phosphite. The present liquid phosphite stabilizers are especially compatible with polyolefins.

This application claims benefit under 35 USC 119(e) of U.S. provisional application No. 60/726,310, filed Oct. 13, 2005.

The present invention is aimed at liquid cyclic phosphites, polyolefin compositions comprising the liquid phosphites and a process for the stabilization of polyolefins with the liquid phosphites.

### BACKGROUND

Organic phosphorus compounds are well known polymer process stabilizers. For Example, Plastics Additives Handbook, 4^{th} Ed., R. Gaechter, H. Mueller, Eds., 1993, pages 40-71, discusses the stabilization of polypropylene (PP) and polyethylene (PE).

Known phosphite and phosphonite stabilizers include for example triphenyl phosphite, diphenyl alkyl phosphites, phenyl dialkyl phosphites, tris(nonylphenyl)phosphite, trilauryl phosphite, trioctadecyl phosphite, distearyl pentaerythritol diphosphite, tris(2,4-di-tert-butylphenyl)phosphite, bis(2,4-di-α-cumylphenyl)pentaerythritol diphosphite, diisodecyl pentaerythritol diphosphite, bis(2,4-di-tert-butylphenyl)pentaerythritol diphosphite (D), bis(2,6-di-tert-butyl-4-methylphenyl)pentaerythritol diphosphite (E), bisisodecyloxy-pentaerythritol diphosphite, bis(2,4-di-tert-butyl-6-methylphenyl)pentaerythritol diphosphite, bis(2,4,6-tri-tert-butylphenyl)pentaerythritol diphosphite, tristearyl sorbitol triphosphite, tetrakis(2,4-di-tert-butylphenyl)4,4′-biphenylene-diphosphonite (H), 6-isooctyloxy-2,4,8,10-tetra-tert-butyl-dibenzo[d,f][1,3,2]dioxaphosphepin (C), 6-fluoro-2,4,8,10-tetra-tert-butyl-12-methyl-dibenzo[d,g][1,3,2]dioxaphosphocin (A), bis(2,4-di-tert-butyl-6-methylphenyl)methyl phosphite, bis(2,4-di-tert-butyl-6-methylphenyl)ethyl phosphite (G), 2,2′,2″-nitrilo[triethyltris(3,3′5,5′-tetra-tert-butyl-1,1′-biphenyl-2,2′-diyl)phosphite] (B), bis(2,4-di-t-butylphenyl)octylphosphite, poly(4,4′-{2,2′-dimethyl-5,5′-di-t-butylphenylsulfide-}octylphosphite), poly(4,4′{-isopropylidenediphenol}-octylphosphite), poly(4,4′-{isopropylidenebis[2,6-dibromophenol]}octylphosphite), poly(4,4′-{2,2′-dimethyl-5,5′-di-t-butylphenylsulfide}-pentaerythrityl diphosphite),

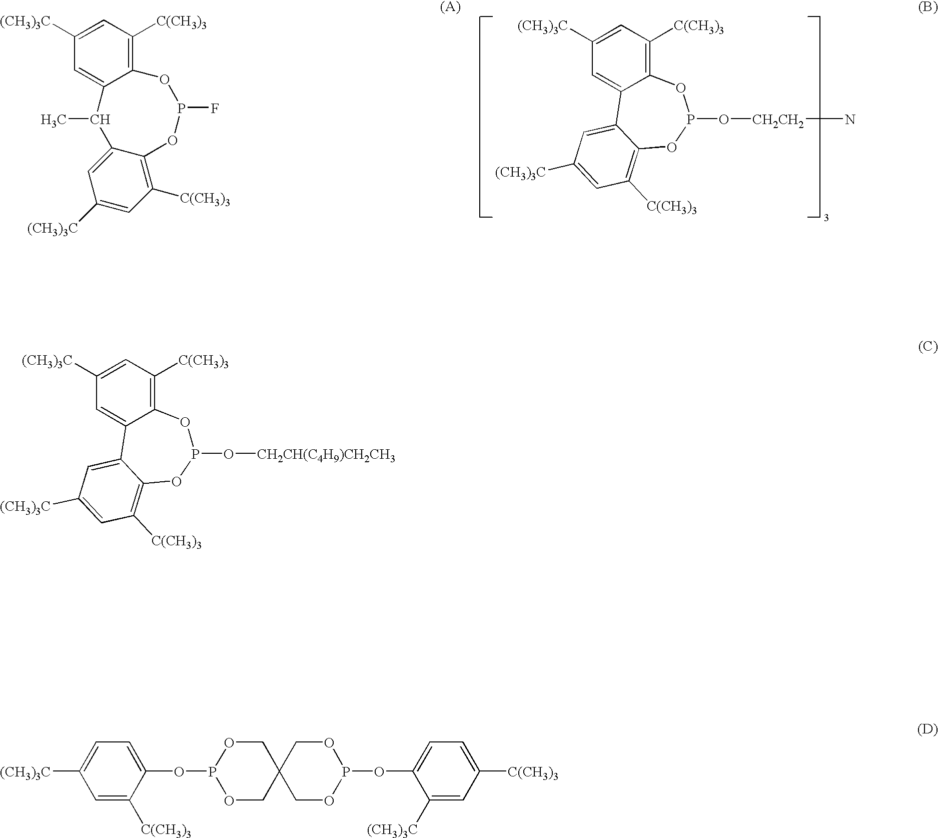

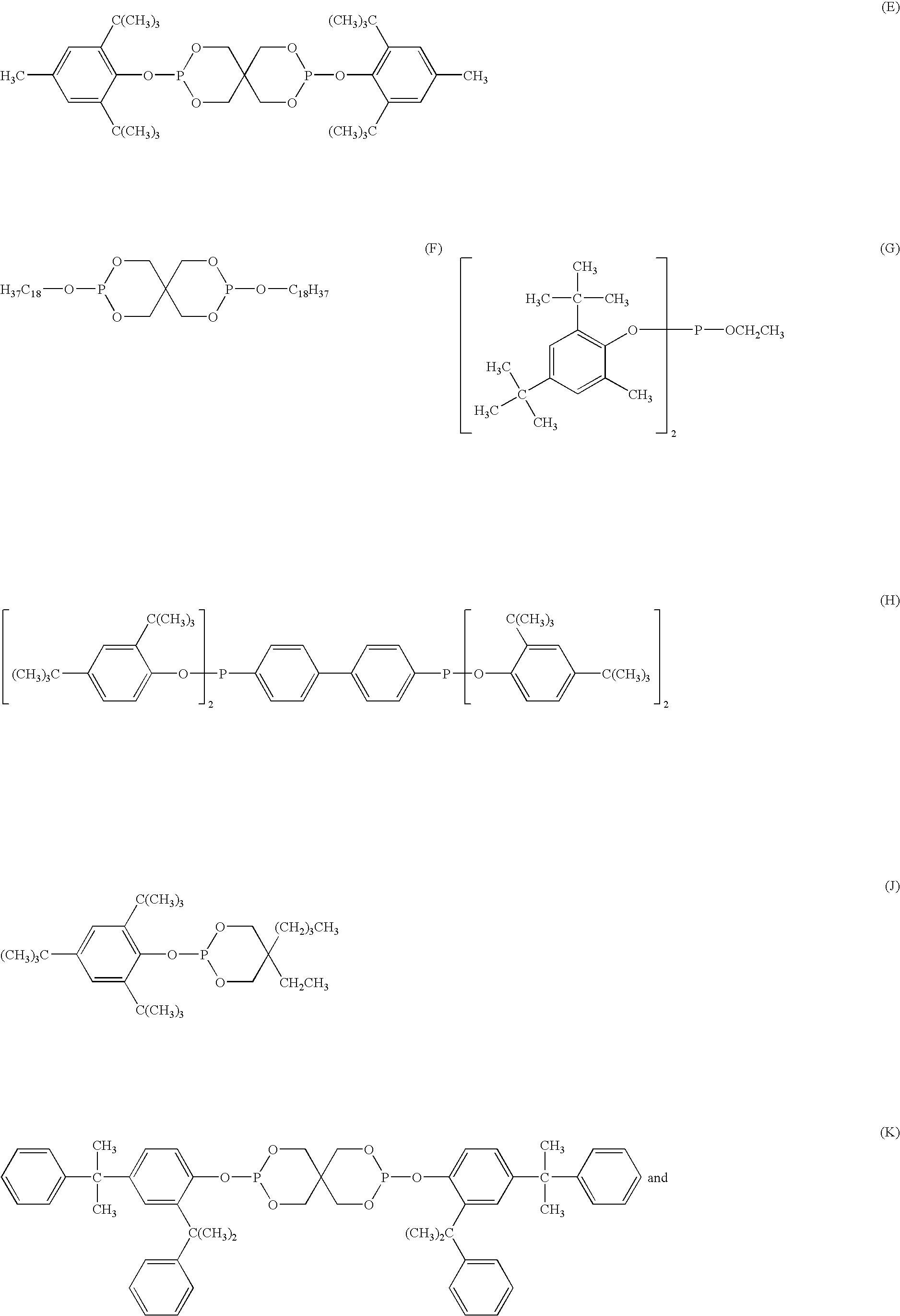

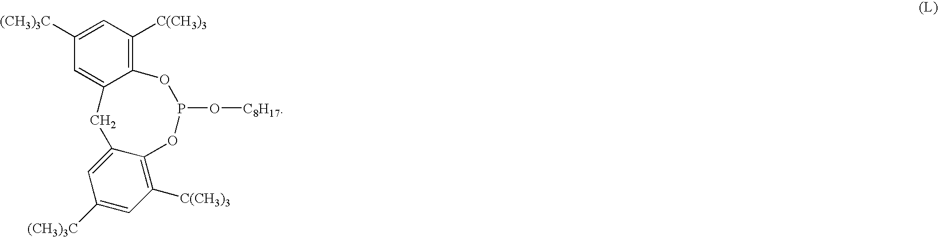

JP 11130789 teaches certain phospites.

JP 10060188 likewise teaches certain phosphites.

U.S. Pat. No. 4,094,855 teaches phosphite stabilizers.

Those in industry still seek phosphite stabilizers that are more compatible with polyolefins than those that are commercially available.

### SUMMARY

It has been found that certain cyclic phosphites are mobile liquids at ambient conditions. The liquid phosphites are exceptionally compatible with polyolefins. The liquid cyclic phosphites are excellent processing stabilizers.

Disclosed are cyclic phosphites of the formula I and II 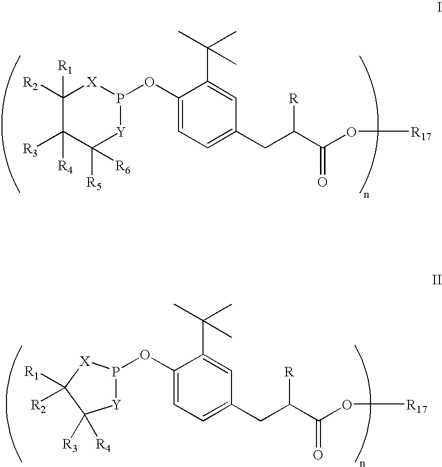
wherein

R is hydrogen or methyl,

R₁, R₂, R₃, R₄, R₅ and R₆ are independently hydrogen, straight or branched chain alkyl of 1 to 24 carbon atoms, cycloalkyl of 5 to 12 carbon atoms, phenylalkyl of 7 to 9 carbon atoms, said phenylalkyl substituted on the phenyl ring by one or two straight or branched chain alkyl of 1 to 12 carbon atoms, aryl of 6 to 10 carbon atoms or said aryl substituted by one or two straight or branched chain alkyl of 1 to 12 carbon atoms, or

R₁ and R₂ together, or R₃ and R₄ together, or R₅ and R₆ together, or one of R₁ or R₂ together with one of R₃ or R₄, or one of R₃ or R₄ together with one of R₅ or R₆, with the ring carbon atoms to which they are attached form a cycloalkyl ring of 5 or 6 carbon atoms,

X and Y are independently —O—, >N—R₂₂ or —S—,

R₂₂ is straight or branched chain alkyl of 1 to 18 carbon atoms,

n is an integer from 1 to 4,

if n=1

R₁₇ is hydrogen, straight or branched chain alkyl of 1 to 24 carbon atoms, cycloalkyl of 5 to 12 carbon atoms, straight or branched chain alkenyl of 2 to 18 carbon atoms, or R₁₇ is —CH₂CH₂-T₃-R₁₉ or —(CᵣH₂ᵣO)ₚ—CᵣH₂ᵣOR₁₉ where T₃ is —O—, —S— or >N—R₂₂, R₂₂ is straight or branched chain alkyl of 1 to 18 carbon atoms, R₁₉ is straight or branched chain alkyl of 1 to 18 carbon atoms, p is an integer from 1 to 20 and r is 2 or 3,

if n=2

R₁₇ is a divalent radical —CₜH₂ₜ— or —(CᵣH₂ᵣO)ₚ—CᵣH₂ᵣ— where t is an integer of from 2 to 16, p is an integer from 1 to 20 and r is 2 or 3, or R₁₇ is a divalent radical —CH₂CH₂-T₃-CH₂CH₂— or —CH₂—CH═CH—CH₂— where T₃ is —O—, —S— or >N—R₂₂ where R₂₂ is straight or branched chain alkyl of 1 to 18 carbon atoms,

if n=3

R₁₇ is a trivalent radical 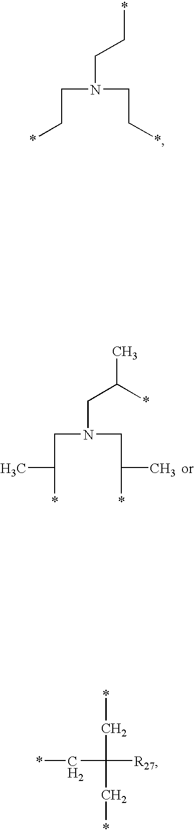
where R₂₇ is hydrogen or straight or branched chain alkyl of 1 to 4 carbon atoms and where * denotes the point of attachment and

if n=4

R₁₇ is an alkanetetrayl of 4 to 12 carbon atoms or is

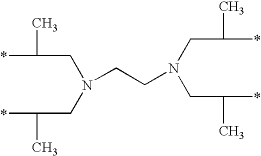

where * denotes the point of attachment,

which cyclic phosphites are in the liquid state at 25° C. and 1 atm of pressure.

Disclosed is a process for stabilizing a polyolefin against the deleterious effects of melt processing, heat aging and exposure to combustion products of natural gas, which process comprises

incorporating into or applying to said polyolefin

an effective stabilizing amount of one or more liquid cyclic phosphites of formula I or II.

Also disclosed is a polyolefin composition stabilized against the deleterious effects of melt processing, heat aging and exposure to combustion products of natural gas, which composition comprises

a polyolefin and

an effective stabilizing amount of one or more liquid cyclic phosphites of formula I or II.

### DETAILED DISCLOSURE

For example, the present liquid cyclic phosphites are of formula I where R₁, R₂, R₃, R₄, R₅ and R₆ are independently hydrogen or straight or branched chain alkyl of 1 to 20 carbon atoms.

For instance, R is hydrogen.

For example, in the cyclic phosphites of formula I, R₁, R₂, R₅ and R₆ are hydrogen or methyl and R₃ and R₄ are methyl, ethyl, i-propyl, n-propyl, n-butyl, sec-butyl or t-butyl.

For instance, in the cyclic phosphites of formula I, X and Y are O and n is 1 or 2.

When n is 1,

R₁₇ is straight or branched chain alkyl of 1 to 18 carbon atoms or is cyclohexyl.

R₁₇ is preferably straight or branched chain alkyl of 1 to 8 carbon atoms.

When n is 2,

R₁₇ is preferably —CₜH₂ₜ— or —CH₂CH₂-T₃-CH₂CH₂— where T₃ is —S— or >N—R₂₂ where R₂₂ is straight or branched chain alkyl of 1 to 12 carbon atoms and t is an integer of from 2 to 6.

Specific cyclic phosphites of this invention include:

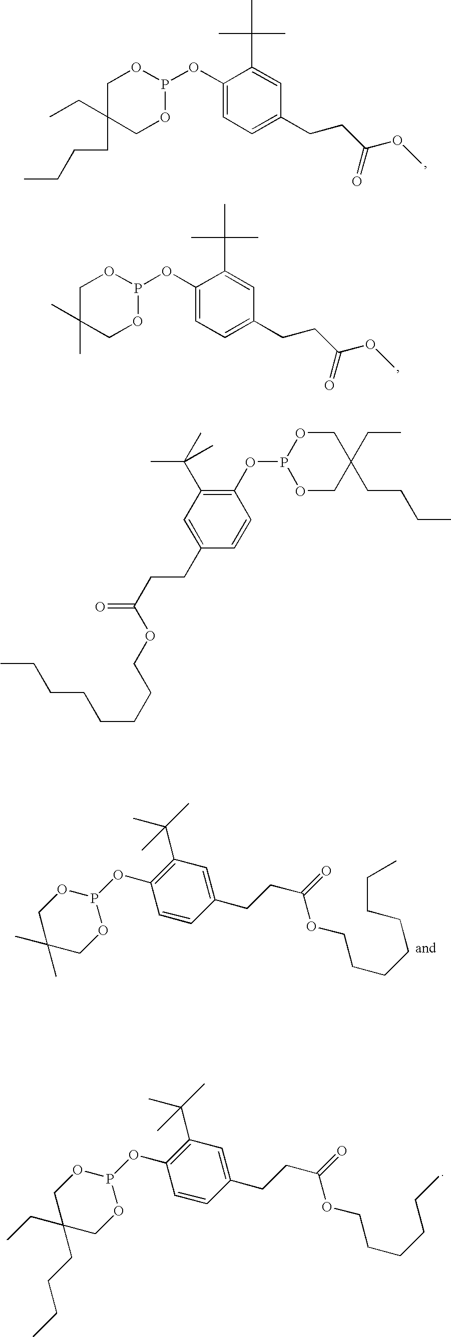

These compounds are all very mobile liquids at ambient conditions, 25° C. and 1 atm pressure.

For example, the present compounds exhibit a viscosity of less than about 1000 mPa·sec at 20° C., or less than about 750 mPa·sec at 20° C., or less than about 150 mPa·s at 40° C. or less than about 135 mPa·s at 40° C.; as measured on a TA Instruments AR-2000N cone/plate rheometer: 40 mm 20 steel cone with peltier plate, constant 10 Pa shear stress, 2° C./min. temperature ramp from 0° C. to 100° C.

The similar compounds where the phenyl group contains a t-butyl group in both the 3 and 5 positions, for example: 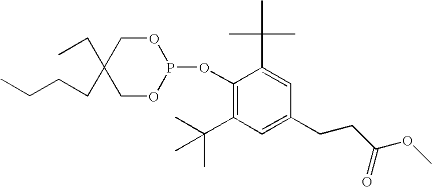
are either solids or very thick liquids at ambient conditions.

Alkyl having up to 24 carbon atoms is a branched or unbranched radical, for example methyl, ethyl, propyl, isopropyl, n-butyl, sec-butyl, isobutyl, tert-butyl, 2-ethylbutyl, n-pentyl, isopentyl, 1-methylpentyl, 1,3-dimethylbutyl, n-hexyl, 1-methylhexyl, n-heptyl, isoheptyl, 1,1,3,3-tetramethylbutyl, 1-methylheptyl, 3-methylheptyl, n-octyl, 2-ethylhexyl, 1,1,3-trimethylhexyl, 1,1,3,3-tetramethylpentyl, nonyl, decyl, undecyl, 1-methylundecyl, dodecyl, 1,1,3,3,5,5-hexamethylhexyl, tridecyl, tetradecyl, pentadecyl, hexadecyl, heptadecyl, octadecyl, icosyl or docosyl.

Alkenyl is an unsaturated version of alkyl, for example isopropenyl, propenyl, hexenyl, heptenyl, and the like.

Cycloalkyl is, for example, cyclopentyl, methylcyclopentyl, dimethylcyclopentyl, cyclohexyl, methylcyclohexyl, dimethylcyclohexyl, trimethylcyclohexyl, tert-butylcyclohexyl, cycloheptyl or cyclooctyl. For example cyclohexyl and tert-butylcyclohexyl.

Phenylalkyl is, for example, benzyl, α-methylbenzyl, α,α-dimethylbenzyl or 2-phenylethyl. For example benzyl and α,α-dimethylbenzyl.

Phenylalkyl substituted on the phenyl radical by 1 or 2 alkyl groups is, for example, 2-methylbenzyl, 3-methylbenzyl, 4-methylbenzyl, 2,4-dimethylbenzyl, 2,6-dimethylbenzyl or 4-tert-butylbenzyl.

Aryl is for example phenyl or naphthyl.

Aryl substituted by alkyl is for example ethylbenzene, toluene, xylene and its isomers, mesitylene or isopropylbenzene.

An alkyltetrayl is for example pentaerythrityl.

The cyclic phosphites of this invention are necessarily liquid at ambient conditions, 25° C. and 1 atmosphere of pressure.

Examples for polyolefins are:

1. Polymers of monoolefins and diolefins, for example polypropylene, polyisobutylene, polybut-1-ene, poly-4-methylpent-1-ene, polyisoprene or polybutadiene, as well as polymers of cycloolefins, for instance of cyclopentene or norbornene, polyethylene (which optionally can be crosslinked), for example high density polyethylene (HDPE), high density and high molecular weight polyethylene (HDPE-HMW), high density and ultrahigh molecular weight polyethylene (HDPE-UHMW), medium density polyethylene (MDPE), low density polyethylene (LDPE), linear low density polyethylene (LLDPE), (VLDPE) and (ULDPE); both Zeigler-Natta and single site (metallocene, etc.) catalyzed.

Polyolefins, i.e. the polymers of monoolefins exemplified in the preceding paragraph, for example polyethylene and polypropylene, can be prepared by different, and especially by the following, methods:

i) radical polymerization (normally under high pressure and at elevated temperature).

ii) catalytic polymerization using a catalyst that normally contains one or more than one metal of groups IVb, Vb, VIb or VIII of the Periodic Table. These metals usually have one or more than one ligand, typically oxides, halides, alcoholates, esters, ethers, amines, alkyls, alkenyls and/or aryls that may be either p- or s-coordinated. These metal complexes may be in the free form or fixed on substrates, typically on activated magnesium chloride, titanium(III) chloride, alumina or silicon oxide. These catalysts may be soluble or insoluble in the polymerization medium. The catalysts can be used by themselves in the polymerization or further activators may be used, typically metal alkyls, metal hydrides, metal alkyl halides, metal alkyl oxides or metal alkyloxanes, said metals being elements of groups Ia, IIa and/or IIIa of the Periodic Table. The activators may be modified conveniently with further ester, ether, amine or silyl ether groups. These catalyst systems are usually termed Phillips, Standard Oil Indiana, Zeigler (-Natta), TNZ (DuPont), metallocene or single site catalysts (SSC).

2. Mixtures of the polymers mentioned under 1.), for example mixtures of polypropylene with polyisobutylene, polypropylene with polyethylene (for example PP/HDPE, PP/LDPE) and mixtures of different types of polyethylene (for example LDPE/HDPE).

3. Copolymers of monoolefins and diolefins with each other or with other vinyl monomers, for example ethylene/propylene copolymers, linear low density polyethylene (LLDPE) and mixtures thereof with low density polyethylene (LDPE), propylene/but-1-ene copolymers, propylene/isobutylene copolymers, ethylene/but-1-ene copolymers, ethylene/hexene copolymers, ethylene/methylpentene copolymers, ethylene/heptene copolymers, ethylene/octene copolymers, propylene/butadiene copolymers, isobutylene/isoprene copolymers, ethylene/alkyl acrylate copolymers, ethylene/alkyl methacrylate copolymers, ethylene/vinyl acetate copolymers and their copolymers with carbon monoxide or ethylene/acrylic acid copolymers and their salts (ionomers) as well as terpolymers of ethylene with propylene and a diene such as hexadiene, dicyclopentadiene or ethylidene-norbornene; and mixtures of such copolymers with one another and with polymers mentioned in 1) above, for example polypropylene/ethylene-propylene copolymers, LDPE/ethylene-vinyl acetate copolymers (EVA), LDPE/ethylene-acrylic acid copolymers (EAA), LLDPE/EVA, LLDPE/EAA and alternating or random polyalkylene/carbon monoxide copolymers and mixtures thereof with other polymers, for example polyamides.

4. Blends of polymers mentioned under 1.) with impact modifiers such as ethylene-propylene-diene monomer copolymers (EPDM), copolymers of ethylene with higher alpha-olefins (such as ethylene-octene copolymers), polybutadiene, polyisoprene, styrene-butadiene copolymers, hydrogenated styrene-butadiene copolymers, styrene-isoprene copolymers, hydrogenated styrene-isoprene copolymers. These blends are commonly referred to in the industry as TPO's (thermoplastic polyolefins).

Polyolefins of the present invention are for example polypropylene homo- and copolymers and polyethylene homo- and copolymers. For instance, polypropylene, high density polyethylene (HDPE), linear low density polyethylene (LLDPE) and polypropylene random and impact (heterophasic) copolymers. Preferred polyolefins of the present invention include polypropylene homopolymers, polypropylene impact (heterophasic) copolymers, blends thereof, and TPO's such as blends of polypropylene homopolymers and impact copolymers with EPDM or ethylene-alpha-olefin copolymers.

In particular, the present polyolefins are low density polyethylene (LDPE).

Melt processing techniques are know and include for example extrusion, co-kneading, pultrusion, injection molding, co-extrusion, fiber extrusion, fiber spinning, film extrusion (cast, blown, blowmolding), rotational molding, and the like.

The present cyclic phosphites are used for example, in amounts of from about 0.01% to about 5% by weight, based on the weight of the polyolefin, from about 0.025% to about 1%, from about 0.05% to about 0.5% by weight, from about 0.01% to about 1%, about 0.01% to about 0.5%, about 0.025% to about 5%, or about 0.05% to about 5% by weight, based on the weight of the polyolefin to be stabilized. For example, the present cyclic phosphites are present at a level of less than about 3% by weight, based on the weight of the polyolefin, or from about 0.01% to about 2.5% by weight, or from about 0.01% to about 2% by weight, based on the weight of the polyolefin.

The incorporation of the present cyclic phosphites and optional further additives into the polyolefin is carried out by known methods, for example before or after molding or also by applying the dissolved or dispersed stabilizer or stabilizer mixture to the polyolefin, with or without subsequent evaporation of the solvent. The stabilizer or stabilizer mixture can also be added to the polyolefins to be stabilized in the form of a masterbatch which contains the present phosphites and optional additives in a concentration of, for example, about 2.5% to about 60% by weight.

The cyclic phosphites and optional further additives can also be added before or during the polymerization or before crosslinking.

The present cyclic phosphites and optional further additives can be incorporated into the polyolefin to be stabilized in pure form or encapsulated in waxes, oils or polymers.

The present cyclic phosphites and optional further additives can also be sprayed onto the polyolefin to be stabilized. It is able to dilute other additives (for example other conventional additives discussed further) or their melts so that it can be sprayed also together with these additives onto the polyolefin to be stabilized. Addition by spraying during the deactivation of the polymerization catalysts is particularly advantageous, it being possible to carry out spraying using, for example, the steam used for deactivation.

In the case of spherically polymerized polyolefins it may, for example, be advantageous to apply the present stabilizers optionally together with other additives, by spraying.

The polyolefin compositions according to the instant invention are useful in the manufacture of polyolefin articles. The said articles are for example woven fibers, non-woven fibers, films, sheets or molded articles.

Further stabilizers include for example hindered phenolic antioxidants, hindered amine light stabilizers, hydroxylamine stabilizers, amine oxide stabilizers, benzofuranone stabilizers and other organic phosphorus stabilizers.

Hindered phenolic antioxidants include for example tris(3,5-di-tert-butyl-4-hydroxybenzyl)isocyanurate, 1,3,5-tris-(3,5-di-tert-butyl-4-hydroxybenzyl)-2,4,6-trimethylbenzene, the calcium salt of the monoethyl ester of 3,5-di-tert-butyl-4-hydroxybenzylphosphonic acid, pentaerythritol tetrakis[3-(3,5-di-tert-butyl-4-hydroxyphenyl)propionate] or octadecyl 3-(3,5-di-tert-butyl-4-hydroxyphenyl)propionate.

Hindered amine light stabilizers include for example

the condensate of 1-(2-hydroxyethyl)-2,2,6,6-tetramethyl-4-hydroxypiperidine and succinic acid,

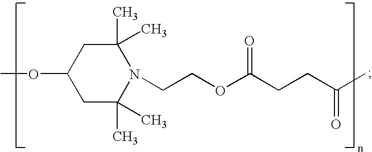

linear or cyclic condensates of N,N′-bis(2,2,6,6-tetramethyl-4-piperidyl)-hexamethylenediamine and 4-tert-octylamino-2,6-dichloro-1,3,5-triazine,

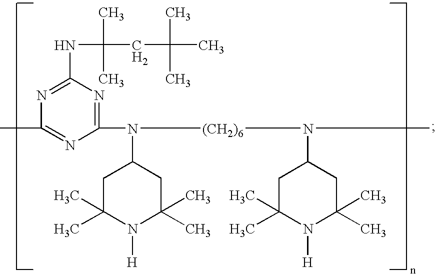

the condensate of 2-chloro-4,6-di-(4-n-butylamino-1,2,2,6,6-pentamethylpiperidyl)-1,3,5-triazine and 1,2-bis-(3-aminopropylamino)ethane,

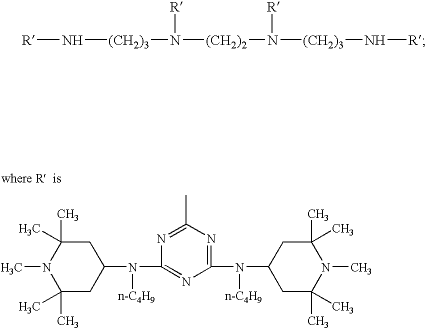

the oligomeric compound which is the condensation product of 4,4′-hexamethylenebis(amino-2,2,6,6-tetramethylpiperidine) and 2,4-dichloro-6-[(2,2,6,6-tetramethylpiperidin-4-yl)butylamino]-s-triazine end-capped with 2-chloro-4,6-bis(dibutylamino)-s-triazine,

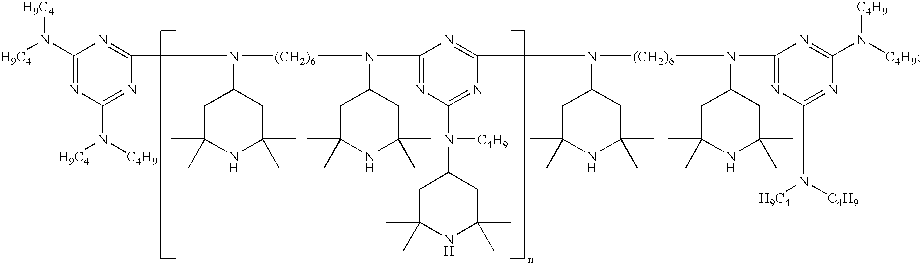

product obtained by reacting a product, obtained by reacting 1,2-bis(3-aminopropylamino)ethane with cyanuric chloride, with (2,2,6,6-tetramethylpiperidin-4-yl)butylamine,

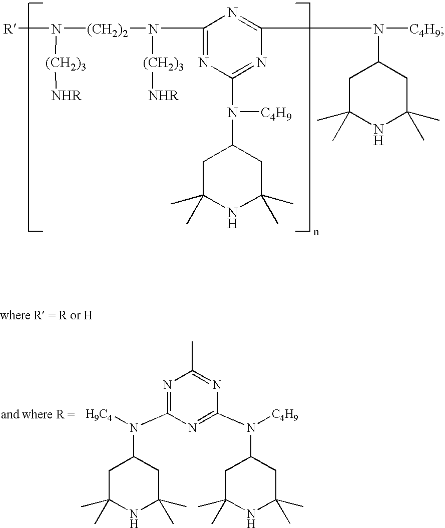

linear or cyclic condensates of N,N′-bis-(2,2,6,6-tetramethyl-4-piperidyl)-hexamethylenediamine and 4-morpholino-2,6-dichloro-1,3,5-triazine,

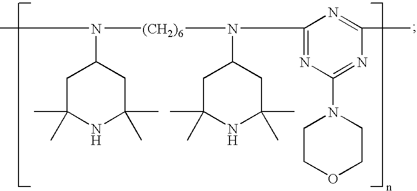

linear or cyclic condensates of N,N′-bis-(1,2,2,6,6-pentamethyl-4-piperidyl)-hexamethylenediamine and 4-morpholino-2,6-dichloro-1,3,5-triazine,

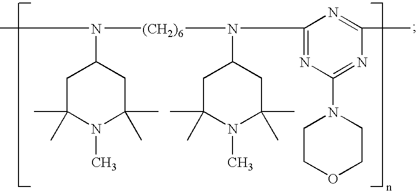

a reaction product of 7,7,9,9-tetramethyl-2-cycloundecyl-1-oxa-3,8-diaza-4-oxospiro[4,5]decane and epichlorohydrin,

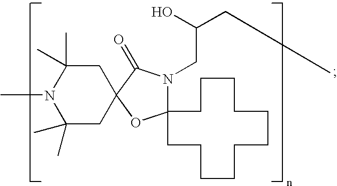

reaction product of maleic acid anhydride-C₁₈-C₂₂-α-olefin-copolymer with 2,2,6,6-tetramethyl-4-aminopiperidine, 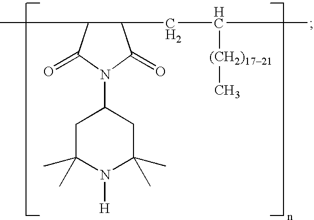
the reaction product of 2,4-bis[(1-cyclohexyloxy-2,2,6,6-piperidin-4-yl)butylamino]-6-chloro-s-triazine with N,N′-bis(3-aminopropyl)ethylenediamine), 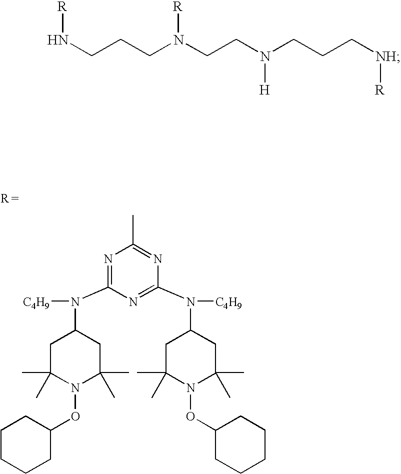
the oligomeric compound which is the condensation product of 4,4′-hexamethylenebis(amino-1-propoxy-2,2,6,6-tetramethylpiperidine) and 2,4-dichloro-6-[(1-propoxy-2,2,6,6-tetramethylpiperidin-4-yl)butylamino]-s-triazine end-capped with 2-chloro-4,6-bis(dibutylamino)-s-triazine, 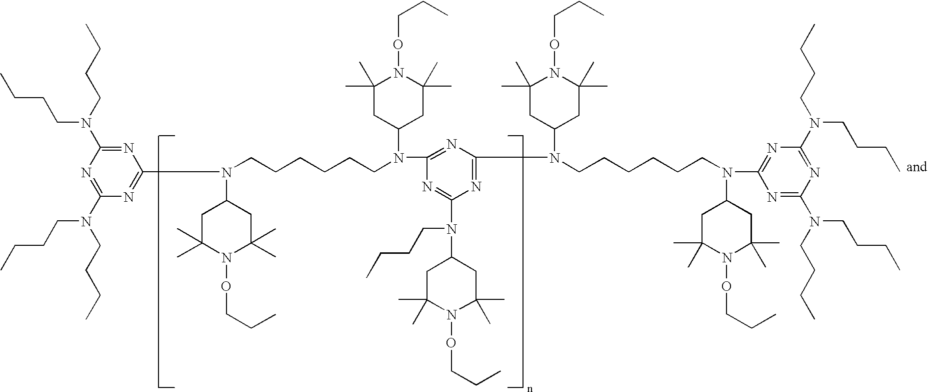
the oligomeric compound which is the condensation product of 4,4′-hexamethylenebis(amino-1,2,2,6,6-pentaamethylpiperidine) and 2,4-dichloro-6-[(1,2,2,6,6-pentaamethylpiperidin-4-yl)butylamino]-s-triazine end-capped with 2-chloro-4,6-bis(dibutylamino)-s-triazine, 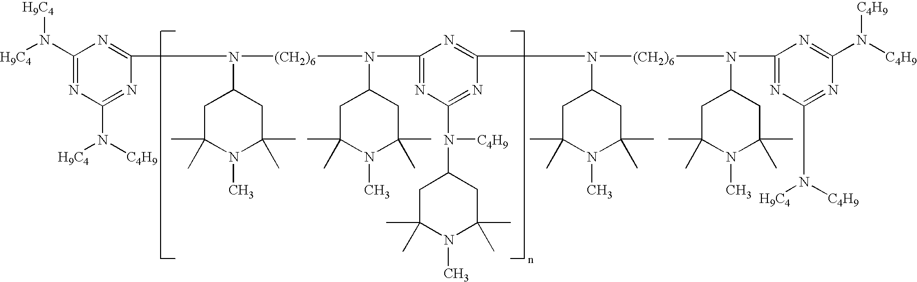
where n is an integer such that the total molecular weight is above about 1000 g/mole.

Hydroxylamine stabilizers are for example N,N-dibenzylhydroxylamine, N,N-diethylhydroxylamine, N,N-dioctylhydroxylamine, N,N-dilaurylhydroxylamine, N,N-didodecylhydroxylamine, N,N-ditetradecylhydroxylamine, N,N-dihexadecylhydroxylamine, N,N-dioctadecylhydroxylamine, N-hexadecyl-N-tetradecylhydroxylamine, N-hexadecyl-N-heptadecylhydroxylamine, N-hexadecyl-N-octadecylhydroxylamine, N-heptadecyl-N-octadecylhydroxylamine, N-methyl-N-octadecylhydroxylamine or N,N-di(hydrogenated tallow)hydroxylamine.

The amine oxide stabilizer is for example Genox™ EP, a di(C₁₆-C₁₈)alkyl methyl amine oxide, CAS# 204933-93-7.

Benzofuranone stabilizers are for example 3-(4-(2-acetoxyethoxy)phenyl)-5,7-di-tert-butyl-benzofuran-2-one, 5,7-di-tert-butyl-3-(4-(2-stearoyloxyethoxy)phenyl)benzofuran-2-one, 3,3′-bis(5,7-di-tert-butyl-3-(4-(2-hydroxyethoxy)phenyl)benzofuran-2-one), 5,7-di-tert-butyl-3-(4-ethoxyphenyl)benzofuran-2-one, 3-(4-acetoxy-3,5-dimethylphenyl)-5,7-di-tert-butyl-benzofuran-2-one, 3-(3,5-dimethyl-4-pivaloyloxyphenyl)-5,7-di-tert-butyl-benzofuran-2-one, 3-(3,4-dimethylphenyl)-5,7-di-tert-butyl-benzofuran-2-one or 3-(2,3-dimethylphenyl)-5,7-di-tert-butyl-benzofuran-2-one.

Further organic phosphorus stabilizers are for example those as disclosed previously. Further organic phosphorus stabilizers are also for example those as disclosed in U.S. Pat. No. 6,541,549 and U.S. Pat. app. No. 2003/0096890, the disclosures of which are hereby incorporated by reference.

These optional stabilizers are employed at the same levels as the present cyclic phosphites.

In addition to the cyclic phosphites and the above optional stabilizers, the following further additives may also be employed. These further stabilizers are employed for example at use levels from about 0.01% to about 5% by weight, based on the weight of the polyolefin.

1. Antioxidants

1.1. Alkylated monophenols, for example 2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(α-methylcyclohexyl)-4,6-dimethylphenol, 2,6-dioctadecyl-4-methylphenol, 2,4,6-tricyclohexylphenol, 2,6-di-tert-butyl-4-methoxymethylphenol, nonylphenols which are linear or branched in the side chains, for example, 2,6-di-nonyl-4-methylphenol, 2,4-dimethyl-6-(1-methylundec-1-yl)phenol, 2,4-dimethyl-6-(1-methylheptadec-1-yl)phenol, 2,4-dimethyl-6-(1-methyltridec-1-yl)phenol and mixtures thereof.

1.2. Alkylthiomethylphenols, for example 2,4-dioctylthiomethyl-6-tert-butylphenol, 2,4-dioctylthiomethyl-6-methylphenol, 2,4-dioctylthiomethyl-6-ethylphenol, 2,6-di-dodecylthiomethyl-4-nonylphenol.

1.3. Hydroquinones and alkylated hydroquinones, for example 2,6-di-tert-butyl-4-methoxyphenol, 2,5-di-tert-butylhydroquinone, 2,5-di-tert-amylhydroquinone, 2,6-diphenyl-4-octadecyloxyphenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenyl stearate, bis-(3,5-di-tert-butyl-4-hydroxyphenyl)adipate.

1.4. Tocopherols, for example α-tocopherol, β-tocopherol, γ-tocopherol, δ-tocopherol and mixtures thereof (Vitamin E).

1.5. Hydroxylated thiodiphenyl ethers, for example 2,2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis-(3,6-di-sec-amylphenol), 4,4′-bis(2,6-dimethyl-4-hydroxyphenyl)disulfide.

1.6. Alkylidenebisphenols, for example 2,2′-methylenebis(6-tert-butyl-4-methylphenol), 2,2′-methylenebis(6-tert-butyl-4-ethylphenol), 2,2′-methylenebis[4-methyl-6-α-methylcyclohexyl)phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylidenebis(4,6-di-tert-butylphenol), 2,2′-ethylidenebis(6-tert-butyl-4-isobutylphenol), 2,2′-methylenebis[6-α-methylbenzyl)-4-nonylphenol], 2,2′-methylenebis[6-(α,α-dimethylbenzyl)-4-nonylphenol], 4,4′-methylenebis(2,6-di-tert-butylphenol), 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methyl-phenyl)-3-n-dodecylmercaptobutane, ethylene glycol bis[3,3-bis(3-tert-butyl-4-hydroxyphenyl)butyrate], bis(3-tert-butyl-4-hydroxy-5-methyl-phenyl)dicyclopentadiene, bis[2-(3′tert-butyl-2-hydroxy-5-methylbenzyl)-6-tert-butyl-4-methylphenyl]terephthalate, 1,1-bis-(3,5-dimethyl-2-hydroxyphenyl)butane, 2,2-bis-(3,5-di-tert-butyl-4-hydroxyphenyl)propane, 2,2-bis-(5-tert-butyl-4-hydroxy2-methylphenyl)-4-n-dodecylmercaptobutane, 1,1,5,5-tetra-(5-tert-butyl-4-hydroxy-2-methylphenyl)pentane.

1.7. Benzyl compounds, for example 3,5,3′,5′-tetra-tert-butyl-4,4′-dihydroxydibenzyl ether, octadecyl-4-hydroxy-3,5-dimethylbenzylmercaptoacetate, tridecyl-4-hydroxy-3,5-di-tert-butylbenzylmercaptoacetate, tris(3,5-di-tert-butyl-4-hydroxybenzyl)amine, 1,3,5-tri-(3,5-di-tert-butyl-4-hydroxybenzyl)-2,4,6-trimethylbenzene, di-(3,5-di-tert-butyl-4-hydroxybenzyl)sulfide, 3,5-di-tert-butyl-4-hydroxybenzyl-mercapto-acetic acid isooctyl ester, bis-(4-tert-butyl-3-hydroxy-2,6-dimethylbenzyl)dithiol terephthalate, 1,3,5-tris-(3,5-di-tert-butyl-4-hydroxybenzyl)isocyanurate, 1,3,5-tris-(4-tert-butyl-3-hydroxy-2,6-dimethylbenzyl)isocyanurate, 3,5-di-tert-butyl-4-hydroxybenzyl-phosphoric acid dioctadecyl ester and 3,5-di-tert-butyl-4-hydroxybenzyl-phosphoric acid monoethyl ester, calcium-salt.

1.8. Hydroxybenzylated malonates, for example dioctadecyl-2,2-bis-(3,5-di-tert-butyl-2-hydroxybenzyl)-malonate, di-octadecyl-2-(3-tert-butyl-4-hydroxy-5-methylbenzyl)-malonate, di-dodecylmercaptoethyl-2,2-bis-(3,5-di-tert-butyl-4-hydroxybenzyl)malonate, bis[4-(1,1,3,3-tetramethylbutyl)phenyl]-2,2-bis(3,5-di-tert-butyl-4-hydroxybenzyl)malonate.

1.9. Aromatic hydroxybenzyl compounds, for example 1,3,5-tris-(3,5-di-tert-butyl-4-hydroxybenzyl)-2,4,6-trimethylbenzene, 1,4-bis(3,5-di-tert-butyl-4-hydroxybenzyl)-2,3,5,6-tetramethylbenzene, 2,4,6-tris(3,5-di-tert-butyl-4-hydroxybenzyl)phenol.

1.10. Triazine compounds, for example 2,4-bis(octylmercapto)-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris-(3,5-di-tert-butyl-4-hydroxyphenoxy)-1,2,3-triazine, 1,3,5-tris-(3,5-di-tert-butyl-4-hydroxybenzyl)isocyanurate, 1,3,5-tris(4-tert-butyl-3-hydroxy-2,6-dimethylbenzyl)isocyanurate, 2,4,6-tris(3,5-di-tert-butyl-4-hydroxyphenylethyl)-1,3,5-triazine, 1,3,5-tris(3,5-di-tert-butyl-4-hydroxyphenylpropionyl)-hexahydro-1,3,5-triazine, 1,3,5-tris(3,5-dicyclohexyl-4-hydroxybenzyl)isocyanurate.

1.11. Benzylphosphonates, for example dimethyl-2,5-di-tert-butyl-4-hydroxybenzylphosphonate, diethyl-3,5-di-tert-butyl-4-hydroxybenzylphosphonate, dioctadecyl3,5-di-tert-butyl-4-hydroxybenzylphosphonate, dioctadecyl-5-tert-butyl-4-hydroxy-3-methylbenzylphosphonate, the calcium salt of the monoethyl ester of 3,5-di-tert-butyl-4-hydroxybenzylphosphonic acid.

1.12. Acylaminophenols, for example 4-hydroxy-lauric acid anilide, 4-hydroxy-stearic acid anilide, 2,4-bis-octylmercapto-6-(3,5-tert-butyl-4-hydroxyanilino)-s-triazine and octyl-N-(3,5-di-tert-butyl-4-hydroxyphenyl)-carbamate.

1.13. Esters of β-(3,5-di-tert-butyl-4-hydroxyphenyl)propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.14. Esters of β-(5-tert-butyl-4-hydroxy-3-methylphenyl)propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis-(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.15. Esters of β-(3,5-dicyclohexyl-4-hydroxyphenyl)propionic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.16. Esters of 3,5-di-tert-butyl-4-hydroxyphenyl acetic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.17. Amides of β-(3,5-di-tert-butyl-4-hydroxyphenyl)propionic acid e.g. N,N′-bis(3,5-di-tert-butyl-4-hydroxyphenylpropionyl)hexamethylenediamide, N,N′-bis(3,5-di-tert-butyl-4-hydroxyphenylpropionyl)trimethylenediamide, N,N′-bis(3,5-di-tert-butyl-4-hydroxyphenylpropionyl)hydrazide, N,N′-bis[2-(3-[3,5-di-tert-butyl-4-hydroxyphenyl]propionyloxy)ethyl]oxamide (Naugard®XL-1 supplied by Uniroyal).

1.18. Ascorbic acid (vitamin C)

1.19. Aminic antioxidants, for example N,N′-di-isopropyl-p-phenylenediamine, N,N′-di-sec-butyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicyclohexyl-p-phenylenediamine, N,N′-diphenyl-p-phenylenediamine, N,N′-bis(2-naphthyl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenlenediamine, 4-(p-toluenesulfamoyl)diphenylamine, N,N′-dimethyl-N,N′-di-sec-butyl-p-phenylenediamine, diphenylamine, N-allyldiphenylamine, 4-isopropoxydiphenylamine, N-phenyl-1-naphthylamine, N-(4-tert-octylphenyl)-1-naphthylamine, N-phenyl-2-naphthylamine, octylated diphenylamine, for example p,p′-di-tert-octyldiphenylamine, 4-n-butylaminophenol, 4-butyrylaminophenol, 4-nonanoylaminophenol, 4-dodecanoylaminophenol, 4-octadecanoylaminophenol, bis(4-methoxyphenyl)amine, 2,6-di-tert-butyl-4-dimethylaminomethylphenol, 2,4′-diaminodiphenylmethane, 4,4′-diaminodiphenylmethane, N,N,N′,N′-tetramethyl-4,4′-diaminodiphenylmethane, 1,2-bis[(2-methylphenyl)amino]ethane, 1,2-bis(phenylamino)propane, (o-tolyl)biguanide, bis[4-(1′,3′-dimethylbutyl)phenyl]amine, tert-octylated N-phenyl-1-naphthylamine, a mixture of mono- and dialkylated tert-butyl/tert-octyl-diphenylamines, a mixture of mono- and dialkylated nonyidiphenylamines, a mixture of mono- and dialkylated dodecyldiphenylamines, a mixture of mono- and dialkylated isopropyl/isohexyldiphenylamines, a mixture of mono- and dialkylated tert-butyldiphenylamines, 2,3-dihydro-3,3-dimethyl-4H-1,4-benzothiazine, phenothiazine, a mixture of mono- and dialkylated tert-butyl/tert-octylphenothiazines, a mixture of mono- and dialkylated tert-octylphenothiazines, N-allylphenothiazin, N,N,N′,N′-tetraphenyl-1,4-diaminobut-2-ene, N,N-bis-(2,2,6,6-tetramethyl-piperid-4-yl-hexamethylenediamine, bis(2,2,6,6-tetramethylpiperid-4-yl)-sebacate, 2,2,6,6-tetramethylpiperidin-4-one, 2,2,6,6-tetramethylpiperidin-4-ol.

2. UV absorbers and light stabilizers

2.1. 2-(2-Hydroxyphenyl)-2H-benzotriazoles, for example known commercial hydroxyphenyl-2H-benzotriazoles and benzotriazoles as disclosed in, U.S. Pat. Nos. 3,004,896; 3,055,896; 3,072,585; 3,074,910; 3,189,615; 3,218,332; 3,230,194; 4,127,586; 4,226,763; 4,275,004; 4,278,589; 4,315,848; 4,347,180; 4,383,863; 4,675,352; 4,681,905, 4,853,471; 5,268,450; 5,278,314; 5,280,124; 5,319,091; 5,410,071; 5,436,349; 5,516,914; 5,554,760; 5,563,242; 5,574,166; 5,607,987, 5,977,219 and 6,166,218 such as 2-(2-hydroxy-5-methylphenyl)-2H-benzotriazole, 2-(3,5-di-t-butyl-2-hydroxyphenyl)-2H-benzotriazole, 2-(2-hydroxy-5-t-butylphenyl)-2H-benzotriazole, 2-(2-hydroxy-5-t-octylphenyl)-2H-benzotriazole, 5-chloro-2-(3,5-di-t-butyl-2-hydroxyphenyl)-2H-benzotriazole, 5-chloro-2-(3-t-butyl-2-hydroxy-5-methylphenyl)-2H-benzotriazole, 2-(3-sec-butyl-5-t-butyl-2-hydroxyphenyl)-2H-benzotriazole, 2-(2-hydroxy-4-octyloxyphenyl)-2H-benzotriazole, 2-(3,5-di-t-amyl-2-hydroxyphenyl)-2H-benzotriazole, 2-(3,5-bis-α-cumyl-2-hydroxyphenyl)-2H-benzotriazole, 2-(3-t-butyl-2-hydroxy-5-(2-(co-hydroxy-octa-(ethyleneoxy)carbonyl-ethyl)-, phenyl)-2H-benzotriazole, 2-(3-dodecyl-2-hydroxy-5-methylphenyl)-2H-benzotriazole, 2-(3-t-butyl-2-hydroxy-5-(2-octyloxycarbonyl)ethylphenyl)-2H-benzotriazole, dodecylated 2-(2-hydroxy-5-methylphenyl)-2H-benzotriazole, 2-(3-t-butyl-2-hydroxy-5-(2-octyloxycarbonylethyl)phenyl)-5-chloro-2H-benzotriazole, 2-(3-tert-butyl-5-(2-(2-ethylhexyloxy)-carbonylethyl)-2-hydroxyphenyl)-5-chloro-2H-benzotriazole, 2-(3-t-butyl-2-hydroxy-5-(2-methoxycarbonylethyl)phenyl)-5-chloro-2H-benzotriazole, 2-(3-t-butyl-2-hydroxy-5-(2-methoxycarbonylethyl)phenyl)-2H-benzotriazole, 2-(3-t-butyl-5-(2-(2-ethylhexyloxy)carbonylethyl)-2-hydroxyphenyl)-2H-benzotriazole, 2-(3-t-butyl-2-hydroxy-5-(2-isooctyloxycarbonylethyl)phenyl-2H-benzotriazole, 2,2′-methylene-bis(4-t-octyl-(6-2H-benzotriazol-2-yl)phenol), 2-(2-hydroxy-3-α-cumyl-5-t-octylphenyl)-2H-benzotriazole, 2-(2-hydroxy-3-t-octyl-5-α-cumylphenyl)-2H-benzotriazole, 5-fluoro-2-(2-hydroxy-3,5-di-α-cumylphenyl)-2H-benzotriazole, 5-chloro-2-(2-hydroxy-3,5-di-α-cumylphenyl)-2H-benzotriazole, 5-chloro-2-(2-hydroxy-3-α-cumyl-5-t-octylphenyl)-2H-benzotriazole, 2-(3-t-butyl-2-hydroxy-5-(2-isooctyloxycarbonylethyl)phenyl)-5-chloro-2H-benzotriazole, 5-trifluoromethyl-2-(2-hydroxy-3-α-cumyl-5-t-octylphenyl)-2H-benzotriazole, 5-trifluoromethyl-2-(2-hydroxy-5-t-octylphenyl)-2H-benzotriazole, 5-trifluoromethyl-2-(2-hydroxy-3,5-di-t-octylphenyl)-2H-benzotriazole, methyl 3-(5-trifluoromethyl-2H-benzotriazol-2-yl)-5-t-butyl-4-hydroxyhydrocinnamate, 5-butylsulfonyl-2-(2-hydroxy-3-α-cumyl-5-t-octylphenyl)-2H-benzotriazole, 5-trifluoromethyl-2-(2-hydroxy-3-α-cumyl-5-t-butylphenyl)-2H-benzotriazole, 5-trifluoromethyl-2-(2-hydroxy-3,5-di-t-butylphenyl)-2H-benzotriazole, 5-trifluoromethyl-2-(2-hydroxy-3,5-di-α-cumylphenyl)-2H-benzotriazole, 5-butylsulfonyl-2-(2-hydroxy-3,5-di-t-butylphenyl)-2H-benzotriazole and 5-phenylsulfonyl-2-(2-hydroxy-3,5-di-t-butylphenyl)-2H-benzotriazole.

2.2. 2-Hydroxybenzophenones, for example the 4-hydroxy, 4-methoxy, 4-octyloxy, 4-decyloxy, 4-dodecyloxy, 4-benzyloxy, 4,2′,4′-trihydroxy and 2′-hydroxy-4,4′-dimethoxy derivatives.

2.3. Esters of substituted and unsubstituted benzoic acids, as for example 4-tert-butylphenyl salicylate, phenyl salicylate, octylphenyl salicylate, dibenzoyl resorcinol, bis(4-tert-butylbenzoyl)resorcinol, benzoyl resorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butylphenyl 3,5-di-tert-butyl-4-hydroxybenzoate.

2.4. Acrylates and malonates, for example, α-cyano-β,β-diphenylacrylic acid ethyl ester or isooctyl ester, α-carbomethoxy-cinnamic acid methyl ester, α-cyano-β-methyl-p-methoxy-cinnamic acid methyl ester or butyl ester, α-carbomethoxy-p-methoxy-cinnamic acid methyl ester, N-(β-carbomethoxy-β-cyanovinyl)-2-methyl-indoline, Sanduvor® PR25, dimethyl p-methoxybenzylidenemalonate (CAS# 7443-25-6), and Sanduvor® PR31, di-(1,2,2,6,6-pentamethylpiperidin-4-yl)p-methoxybenzylidenemalonate (CAS #147783-69-5).

2.5. Nickel compounds, for example nickel complexes of 2,2′-thio-bis-[4-(1,1,3,3-tetramethylbutyl)phenol], such as the 1:1 or 1:2 complex, with or without additional ligands such as n-butylamine, triethanolamine or N-cyclohexyldiethanolamine, nickel dibutyldithiocarbamate, nickel salts of the monoalkyl esters, e.g. the methyl or ethyl ester, of 4-hydroxy-3,5-di-tert-butylbenzylphosphonic acid, nickel complexes of ketoximes, e.g. of 2-hydroxy-4-methylphenyl undecylketoxime, nickel complexes of 1-phenyl-4-lauroyl-5-hydroxypyrazole, with or without additional ligands.

2.6. Sterically hindered amine stabilizers, for example 4-hydroxy-2,2,6,6-tetramethylpiperidine, 1-allyl-4-hydroxy-2,2,6,6-tetramethylpiperidine, 1-benzyl-4-hydroxy-2,2,6,6-tetramethylpiperidine, bis(2,2,6,6-tetramethyl-4-piperidyl)sebacate, bis(2,2,6,6-tetramethyl-4-piperidyl)succinate, bis(1,2,2,6,6-pentamethyl-4-piperidyl)sebacate, bis(1-octyloxy-2,2,6,6-tetramethyl-4-piperidyl)sebacate, bis(1,2,2,6,6-pentamethyl-4-piperidyl)n-butyl-3,5-di-tert-butyl-4-hydroxybenzylmalonate, the condensate of 1-(2-hydroxyethyl)-2,2,6,6-tetramethyl-4-hydroxypiperidine and succinic acid, linear or cyclic condensates of N,N′-bis(2,2,6,6-tetramethyl-4-piperidyl)hexamethylenediamine and 4-tert-octylamino-2,6-dichloro-1,3,5-triazine, tris(2,2,6,6-tetramethyl-4-piperidyl)nitrilotriacetate, tetrakis(2,2,6,6-tetramethyl-4-piperidyl)-1,2,3,4-butane-tetracarboxylate, 1,1′-(1,2-ethanediyl)-bis(3,3,5,5-tetramethylpiperazinone), 4-benzoyl-2,2,6,6-tetramethylpiperidine, 4-stearyloxy-2,2,6,6-tetramethylpiperidine, bis(1,2,2,6,6-pentamethylpiperidyl)-2-n-butyl-2-(2-hydroxy-3,5-di-tert-butylbenzyl)malonate, 3-n-octyl-7,7,9,9-tetramethyl-1,3,8-triazaspiro[4.5]decan-2,4-dione, bis(1-octyloxy-2,2,6,6-tetramethylpiperidyl)sebacate, bis(1-octyloxy-2,2,6,6-tetramethylpiperidyl)succinate, linear or cyclic condensates of N,N′-bis-(2,2,6,6-tetramethyl-4-piperidyl)-hexamethylenediamine and 4-morpholino-2,6-dichloro-1,3,5-triazine, the condensate of 2-chloro-4,6-bis(4-n-butylamino-2,2,6,6-tetramethylpiperidyl)-1,3,5-triazine and 1,2-bis(3-aminopropylamino)ethane, the condensate of 2-chloro-4,6-di-(4-n-butylamino-1,2,2,6,6-pentamethylpiperidyl)-1,3,5-triazine and 1,2-bis-(3-aminopropylamino)ethane, 8-acetyl-3-dodecyl-7,7,9,9-tetramethyl-1,3,8-triazaspiro[4.5]decane-2,4-dione, 3-dodecyl-1-(2,2,6,6-tetramethyl-4-piperidyl)pyrrolidin-2,5-dione, 3-dodecyl-1-(1,2,2,6,6-pentamethyl-4-piperidyl)pyrrolidine-2,5-dione, a mixture of 4-hexadecyloxy- and 4-stearyloxy-2,2,6,6-tetramethylpiperidine, a condensation product of N,N′-bis(2,2,6,6-tetramethyl-4-piperidyl)hexamethylenediamine and 4-cyclohexylamino-2,6-dichloro-1,3,5-triazine, a condensation product of 1,2-bis(3-aminopropylamino)ethane and 2,4,6-trichloro-1,3,5-triazine as well as 4-butylamino-2,2,6,6-tetramethylpiperidine (CAS Reg. No. [136504-96-6]); N-(2,2,6,6-tetramethyl-4-piperidyl)-n-dodecylsuccinimid, N-(1,2,2,6,6-pentamethyl-4-piperidyl)-n-dodecylsuccinimid, 2-undecyl-7,7,9,9-tetramethyl-1-oxa-3,8-diaza-4-oxo-spiro[4,5]decane, a reaction product of 7,7,9,9-tetramethyl-2-cycloundecyl-1-oxa-3,8-diaza-4-oxospiro[4,5]decane and epichlorohydrin, 1,1-bis(1,2,2,6,6-pentamethyl-4-piperidyloxycarbonyl)-2-(4-methoxyphenyl)ethene, N,N′-bis-formyl-N,N′-bis(2,2,6,6-tetramethyl-4-piperidyl)hexamethylenediamine, diester of 4-methoxy-methylene-malonic acid with 1,2,2,6,6-pentamethyl-4-hydroxypiperidine, poly[methylpropyl-3-oxy-4-(2,2,6,6-tetramethyl-4-piperidyl)]siloxane, reaction product of maleic acid anhydride-α-olefin-copolymer with 2,2,6,6-tetramethyl-4-aminopiperidine or 1,2,2,6,6-pentamethyl-4-aminopiperidine.

The sterically hindered amine may also be one of the compounds described in U.S. Pat. No. 5,980,783, the relevant parts of which are hereby incorporated by reference, that is compounds of component I-a), I-b), I-c), I-d), I-e), I-f), I-g), I-h), I-i), I-j), I-k) or I-l), in particular the light stabilizer 1-a-1, 1-a-2, 1-b-1, 1-c-1, 1-c-2, 1-d-1, 1-d-2, 1-d-3, 1-e-1, 1-f-1, 1-g-1, 1-g-2 or 1-k-1 listed on columns 64-72 of said U.S. Pat. No. 5,980,783.

The sterically hindered amine may also be one of the compounds described in U.S. Pat. Nos. 6,046,304 and 6,297,299, the disclosures of which are hereby incorporated by reference, for example compounds as described in claims 10 or 38 or in Examples 1-12 or D-1 to D-5 therein.

2.7. Sterically hindered amines substituted on the N-atom by a hydroxy-substituted alkoxy group, for example compounds such as 1-(2-hydroxy-2-methylpropoxy)-4-octadecanoyloxy-2,2,6,6-tetramethylpiperidine, 1-(2-hydroxy-2-methylpropoxy)-4-hexadecanoyloxy-2,2,6,6-tetramethylpiperidine, the reaction product of 1-oxyl-4-hydroxy-2,2,6,6-tetramethylpiperidine with a carbon radical from t-amylalcohol, 1-(2-hydroxy-2-methylpropoxy)-4-hydroxy-2,2,6,6-tetramethylpiperidine, 1-(2-hydroxy-2-methylpropoxy)-4-oxo-2,2,6,6-tetramethylpiperidine, bis(1-(2-hydroxy-2-methylpropoxy)-2,2,6,6-tetramethylpiperidin-4-yl)sebacate, bis(1-(2-hydroxy-2-methylpropoxy)-2,2,6,6-tetramethylpiperidin-4-yl)adipate, bis(1-(2-hydroxy-2-methylpropoxy)-2,2,6,6-tetramethylpiperidin-4-yl)succinate, bis(1-(2-hydroxy-2-methylpropoxy)-2,2,6,6-tetramethylpiperidin-4-yl)glutarate and 2,4-bis{N-[1-(2-hydroxy-2-methylpropoxy)-2,2,6,6-tetramethylpiperidin-4-yl]-N-butylamino}-6-(2-hydroxyethylamino)-s-triazine.

2.8. Oxamides, for example 4,4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide and its mixture with 2-ethoxy-2′-ethyl-5,4′-di-tert-butoxanilide, mixtures of o- and p-methoxy-disubstituted oxanilides and mixtures of o- and p-ethoxy-disubstituted oxanilides.

2.9. Tris-aryl-o-hydroxyphenyl-s-triazines, for example known commercial tris-aryl-o-hydroxyphenyl-s-trazines and triazines as disclosed in, U.S. Pat. Nos. 3,843,371; 4,619,956; 4,740,542; 5,096,489; 5,106,891; 5,298,067; 5,300,414; 5,354,794; 5,461,151; 5,476,937; 5,489,503; 5,543,518; 5,556,973; 5,597,854; 5,681,955; 5,726,309; 5,736,597; 5,942,626; 5,959,008; 5,998,116; 6,013,704; 6,060,543; 6,187,919; 6,242,598 and 6,468,958, for example 4,6-bis-(2,4-dimethylphenyl)-2-(2-hydroxy-4-octyloxyphenyl)-s-trazine, Cyasorb® 1164, Cytec Corp, 4,6-bis-(2,4-dimethylphenyl)-2-(2,4-dihydroxyphenyl)-s-triazine, 2,4-bis(2,4-dihydroxyphenyl)-6-(4-chlorophenyl)-s-triazine, 2,4-bis[2-hydroxy-4-(2-hydroxyethoxy)phenyl]-6-(4-chlorophenyl)-s-triazine, 2,4-bis[2-hydroxy-4-(2-hydroxy-4-(2-hydroxyethoxy)phenyl]-6-(2,4-dimethylphenyl)-s-triazine, 2,4-bis[2-hydroxy-4-(2-hydroxyethoxy)phenyl]-6-(4-bromophenyl)-s-triazine, 2,4-bis[2-hydroxy-4-(2-acetoxyethoxy)phenyl]-6-(4-chlorophenyl)-s-triazine, 2,4-bis(2,4-dihydroxyphenyl)-6-(2,4-dimethylphenyl)-s-triazine, 2,4-bis(4-biphenylyl)-6-(2-hydroxy-4-octyloxycarbonylethylideneoxyphenyl)-s-triazine, 2-phenyl-4-[2-hydroxy-4-(3-sec-butyloxy-2-hydroxypropyloxy)phenyl]-6-[2-hydroxy-4-(3-sec-amyloxy-2-hydroxypropyloxy)-phenyl]-s-triazine, 2,4-bis(2,4-dimethylphenyl)-6-[2-hydroxy-4-(3-benzyloxy-2-hydroxypropyloxy)phenyl]-s-triazine, 2,4-bis(2-hydroxy-4-n-butyloxyphenyl)-6-(2,4-di-n-butyloxyphenyl)-s-triazine, 2,4-bis(2,4-dimethylphenyl)-6-[2-hydroxy-4-(3-nonyloxy*-2-hydroxypropyloxy)-5-α-cumylphenyl]-s-triazine (* denotes a mixture of octyloxy, nonyloxy and decyloxy groups), methylenebis-{2,4-bis(2,4-dimethylphenyl)-6-[2-hydroxy-4-(3-butyloxy-2-hydroxypropoxy)-phenyl]-s-triazine}, methylene bridged dimer mixture bridged in the 3:5′, 5:5′ and 3:3′ positions in a 5:4:1 ratio, 2,4,6-tris(2-hydroxy-4-isooctyloxycarbonylisopropylideneoxyphenyl)-s-triazine, 2,4-bis(2,4-dimethylphenyl)-6-(2-hydroxy-4-hexyloxy-5-α-cumylphenyl)-s-triazine, 2-(2,4,6-trimethylphenyl)-4,6-bis[2-hydroxy-4-(3-butyloxy-2-hydroxypropyloxy)phenyl]-s-triazine, 2,4,6-tris[2-hydroxy-4-(3-sec-butyloxy-2-hydroxypropyloxy)phenyl]-s-triazine, mixture of 4,6-bis-(2,4-dimethylphenyl)-2-(2-hydroxy-4-(3-dodecyloxy-2-hydroxypropoxy)-phenyl)-s-triazine and 4,6-bis-(2,4-dimethylphenyl)-2-(2-hydroxy-4-(3-tridecyloxy-2-hydroxypropoxy)-phenyl)-s-triazine, 4,6-bis-(2,4-dimethylphenyl)-2-(2-hydroxy-4-(3-(2-ethylhexyloxy)-2-hydroxypropoxy)-phenyl)-s-triazine and 4,6-diphenyl-2-(4-hexyloxy-2-hydroxyphenyl)-s-triazine.

3. Metal deactivators, for example N,N′-diphenyloxamide, N-salicylal-N′-salicyloyl hydrazine, N,N′-bis(salicyloyl)hydrazine, N,N′-bis(3,5-di-tert-butyl-4-hydroxyphenylpropionyl)hydrazine, 3-salicyloylamino-1,2,4-triazole, bis(benzylidene)oxalyl dihydrazide, oxanilide, isophthaloyl dihydrazide, sebacoyl bisphenylhydrazide, N,N′-diacetyladipoyl dihydrazide, N,N′-bis(salicyloyl)oxalyl dihydrazide, N,N′-bis(salicyloyl)thiopropionyl dihydrazide.

4. Phosphites and phosphonites, for example triphenyl phosphite, diphenyl alkyl ®phosphites, phenyl dialkyl phosphites, tris(nonylphenyl)phosphite, trilauryl phosphite, trioctadecyl phosphite, distearyl pentaerythritol diphosphite, tris(2,4-di-tert-butylphenyl)phosphite, diisodecyl pentaerythritol diphosphite, bis(2,4-di-tert-butylphenyl)pentaerythritol diphosphite, bis(2,6-di-tert-butyl-4-methylphenyl)-pentaerythritol diphosphite, diisodecyloxypentaerythritol diphosphite, bis(2,4-di-tert-butyl-6-methylphenyl)pentaerythritol diphosphite, bis(2,4,6-tris(tert-butylphenyl)pentaerythritol diphosphite, tristearyl sorbitol triphosphite, tetrakis(2,4-di-tert-butylphenyl)4,4′-biphenylene diphosphonite, 6-isooctyloxy-2,4,8,10-tetra-tert-butyl-dibenzo[d,f][1,3,2]dioxaphosphepin, 6-fluoro-2,4,8,10-tetra-tert-butyl-12-methyl-dibenzo[d,g][1,3,2]dioxaphosphocin, bis(2,4-di-tert-butyl-6-methylphenyl)methyl phosphite, bis(2,4-di-tert-butyl-6-methylphenyl)ethyl phosphite, 2,2′,2″-nitrilo[triethyltris(3,3′,5,5′-tetra-tert-butyl-1,1′-biphenyl-2,2′-diyl)phosphite], 2-ethylhexyl(3,3′,5,5′-tetra-tert-butyl-1,1′-biphenyl-2,2′-diyl)phosphite.

Especially preferred are the following phosphites:

Tris(2,4-di-tert-butylphenyl)phosphite, tris(nonylphenyl)phosphite,

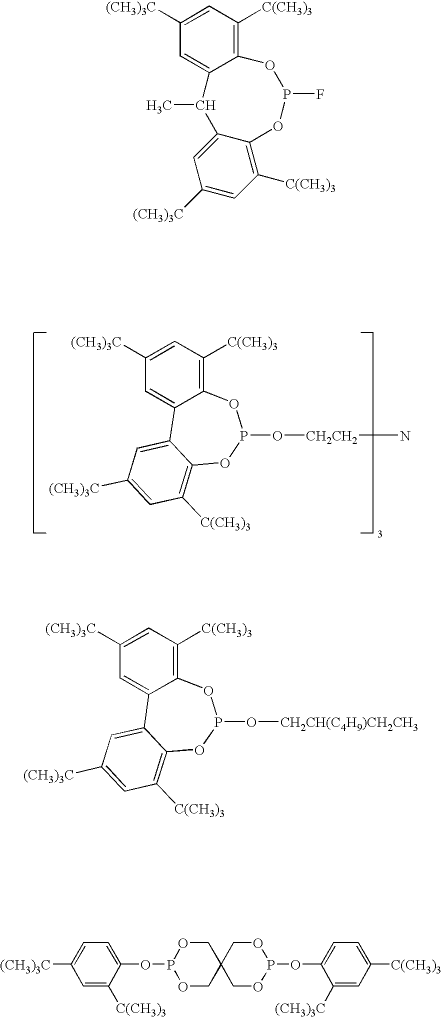

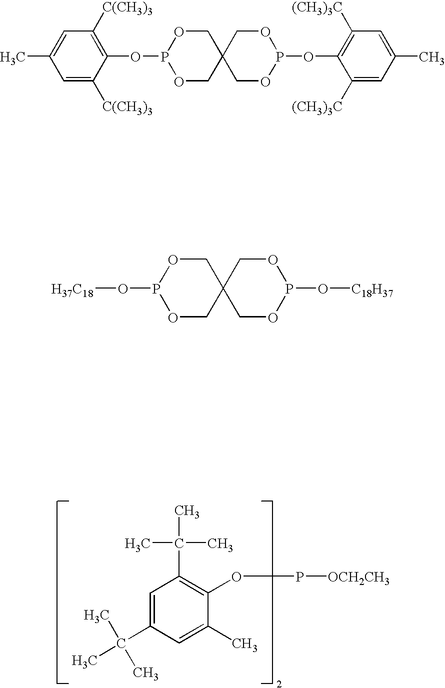

5. Hydroxylamines, for example N,N-dibenzylhydroxylamine, N,N-diethylhydroxylamine, N,N-dioctylhydroxylamine, N,N-dilaurylhydroxylamine, N,N-ditetradecylhydroxylamine, N,N-dihexadecylhydroxylamine, N,N-dioctadecylhydroxylamine, N-hexadecyl-N-octadecylhydroxylamine, N-heptadecyl-N-octadecylhydroxylamine, N-methyl-N-octadecylhydroxylamine and the N,N-dialkylhydroxylamine derived from hydrogenated tallow amine.

6. Nitrones, for example N-benzyl-α-phenylnitrone, N-ethyl-α-methylnitrone, N-octyl-α-heptylnitrone, N-lauryl-α-undecyInitrone, N-tetradecyl-α-tridcyinitrone, N-hexadecyl-α-pentadecylnitrone, N-octadecyl-α-heptadecyinitrone, N-hexadecyl-α-heptadecylnitrone, N-ocatadecyl-α-pentadecylnitrone, N-heptadecyl-α-heptadecylnitrone, N-octadecyl-α-hexadecylnitrone, N-methyl-α-heptadecylnitrone and the nitrone derived from N,N-dialkylhydroxylamine derived from hydrogenated tallow amine.

7. Amine oxides, for example amine oxide derivatives as disclosed in U.S. Pat. Nos. 5,844,029 and 5,880,191, didecyl methyl amine oxide, tridecyl amine oxide, tridodecyl amine oxide and trihexadecyl amine oxide.

8. Benzofuranones and indolinones, for example those disclosed in U.S. Pat. Nos. 4,325,863, 4,338,244, 5,175,312, 5,216,052, 5,252,643 5,369,159 5,356,966 5,367,008 5,428,177 or 5,428,162 or 3-[4-(2-acetoxyethoxy)phenyl]-5,7-di-tert-butyl-benzofuran-2-one, 5,7-di-tert-butyl-3-[4-(2-stearoyloxyethoxy)phenyl]benzofuran-2-one, 3,3′-bis[5,7-di-tert-butyl-3-(4-[2-hydroxyethoxy]phenyl)benzofuran-2-one], 5,7-di-tert-butyl-3-(4-ethoxyphenyl)benzofuran-2-one, 3-(4-acetoxy-3,5-dimethylphenyl)-5,7-di-tert-butyl-benzofuran-2-one, 3-(3,5-dimethyl-4-pivaloyloxyphenyl)-5,7-di-tert-butyl-benzofuran-2-one, 3-(3,4-dimethylphenyl)-5,7-di-tert-butyl-benzofuran-2-one, Irganox® HP-136, Ciba Specialty Chemicals Corp., and 3-(2,3-dimethylphenyl)-5,7-di-tert-butyl-benzofuran-2-one.

9. Thiosynergists, for example dilauryl thiodipropionate or distearyl thiodipropionate.

10. Peroxide scavengers, for example esters of β-thiodipropionic acid, for example the lauryl, stearyl, myristyl or tridecyl esters, mercaptobenzimidazole or the zinc salt of 2-mercaptobenzimidazole, zinc dibutyldithiocarbamate, dioctadecyl disulfide, pentaerythritol tetrakis(β-dodecylmercapto)propionate.

11. Basic co-stabilizers, for example melamine, polyvinylpyrrolidone, dicyandiamide, triallyl cyanurate, urea derivatives, hydrazine derivatives, amines, polyamides, polyurethanes, alkali metal salts and alkaline earth metal salts of higher fatty acids, for example, calcium stearate, zinc stearate, magnesium behenate, magnesium stearate, sodium ricinoleate and potassium palmitate, antimony pyrocatecholate or zinc pyrocatecholate.

12. Nucleating agents, for example inorganic substances such as talcum, metal oxides such as titanium dioxide or magnesium oxide, phosphates, carbonates or sulfates of, preferably, alkaline earth metals; organic compounds such as mono- or polycarboxylic acids and the salts thereof, e.g. 4-tert-butylbenzoic acid, adipic acid, diphenylacetic acid, sodium succinate or sodium benzoate; polymeric compounds such as ionic copolymers (ionomers).

13. Fillers and reinforcing agents, for example calcium carbonate, silicates, glass fibres, glass bulbs, asbestos, talc, kaolin, mica, barium sulfate, metal oxides and hydroxides, carbon black, graphite, wood flour and flours or fibers of other natural products, synthetic fibers.

14. Dispersing Agents, such as polyethylene oxide waxes or mineral oil.

15. Other additives, for example plasticizers, lubricants, emulsifiers, pigments, dyes, optical brighteners, rheology additives, catalysts, flow-control agents, slip agents, crosslinking agents, crosslinking boosters, halogen scavengers, smoke inhibitors, flameproofing agents, antistatic agents, clarifiers such as substituted and unsubstituted bisbenzylidene sorbitols, benzoxazinone UV absorbers such as 2,2′-p-phenylene-bis(3,1-benzoxazin-4-one), Cyasorb® 3638 (CAS# 18600-594), and blowing agents.

The fillers and reinforcing agents (item 13 in the list), for example talc, calcium carbonate, mica or kaolin, are added to the polyolefins in concentrations of about 0.01% to about 40% by weight, based on the overall weight of the polyolefins to be stabilized.

The fillers and reinforcing agents (item 13 in the list), for example metal hydroxides, especially aluminum hydroxide or magnesium hydroxide, are added to the polyolefins in concentrations of about 0.01% to about 60% by weight, based on the overall weight of the polyolefins to be stabilized.

Carbon black as filler is added to the polyolefins in concentrations, judiciously, of from about 0.01% to about 5% by weight, based on the overall weight of the polyolefins to be stabilized.

Glass fibers as reinforcing agents are added to the polyolefins in concentrations, judiciously, of from about 0.01% to about 20% by weight, based on the overall weight of the polyolefins to be stabilized.

The following Examples illustrate the invention in more detail. Parts and percentages are by weight unless otherwise indicated.

### PREPARATION EXAMPLES

The phenols in the preparation Examples are prepared as described in Zhural Organicheskoi Khimii, 20(12), 2608-11 and U.S. Pat. Nos. 5,072,055 and 3,644,482. The diols and phosphorus trichloride are commercially available.

### Compound Example 1

### Preparation of 3-[3-tert-butyl-4-(5,5-dimethyl-1,3,2-dioxaphosphorinan-2-yloxy)-phenyl]-propionic acid methyl ester

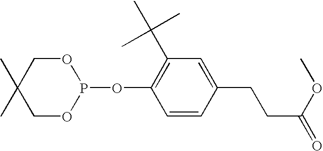

To a solution of 30 g (0.3 mole) 2,2-dimethyl-1,3-propandiol in 700 mL of toluene is added dropwise at 60° C. 26 mL (0.3 mole) of phosphorus trichloride. After 55 min., the P³¹ NMR shows that the PCl₃ (signal at 220 ppm) is fully reacted and a new product is formed (signal at 148 ppm). The temperature is raised to 80° C. Now a solution of 71 g (0.3 mole) 3-(3-tert-butyl-4-hydroxy-phenyl)-propionic acid methyl ester and 200 mL of triethylamine in 300 mL toluene are added dropwise (30 min.). The reaction mixture turns into a suspension which is stirred for 2 h 30 min. After 2 h 15 min the P³¹ NMR shows that the educt (signal at 148 ppm) is fully reacted. After filtration and removal of the toluene (rotary evaporator) the product is isolated. Yield: 90 g (0.244 mole=82% of theory). The title compound is a crude yellow oil, molecular weight 368.41 (C₁₉H₂₉O₅P), P³¹ NMR (400 MHz, CDCl₃, reference is PCl₃ (219 ppm) window is −230 to +230 ppm) signals at: 115 ppm (major peak). Total reaction time: 3 h 25 min. Filtration through a neutral alumina column provides a mobile colorless liquid.

This compound is Phos2 in the application examples.

| | Calculated | Found |
|---|---|---|
| % P | 8.41 | 8.61 |

### Compound Example 2

### Preparation of 3-[3-tert-butyl-4-(5,5-dimethyl-[1,3,2]dioxaphosphinan-2-yloxy)-phenyl]-propionic acid octyl ester

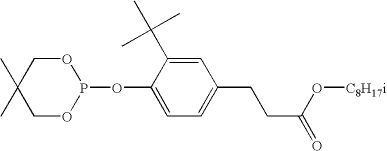

To a solution of 30 g (0.3 mole) 2,2-dimethyl-1,3-propandiol in 750 mL of toluene is added dropwise at 60° C. 26 mL (0.3 mole) of phosphorus trichloride. After 55 min., the P³¹ NMR shows that the PCl₃ (signal at 220 ppm) is fully reacted and a new product is formed (signal at 148 ppm). The temperature is raised to 80° C. Now a solution of 100.35 g (0.3 mole) 3-(3-tert-butyl-4-hydroxy-phenyl)-propionic acid isooctyl ester and 200 mL of triethylamine in 300 mL toluene is added dropwise (1 h). The reaction mixture turns into a suspension which is stirred for 2 h. After 1 h 30 min. the P³¹ NMR shows that the educt (signal at 148 ppm) is fully reacted and a new signal is obtained (116 ppm). After filtration and removal of the toluene (rotary evaporator) the product is isolated. Yield: 130 g (0.279 mole=93% of theory). The title compound is a crude yellow oil, molecular weight 368.41 (C₁₉H₂₉O₅P), P³¹ NMR (400 MHz, CDCl₃, reference is PCl₃ (219 ppm) window is −230 to +230 ppm) signals at: 116 ppm (major peak). Total reaction time: 2 h 25 min. Filtration through a neutral alumina column provides a mobile colorless liquid.

| | Calculated | Found |
|---|---|---|
| % P | 6.64 | 6.8 |

### Compound Example 3

### Preparation of 3-[3-tert-butyl-4-(5-butyl-5-ethyl-1,3,2-dioxaphosphorinan-2-yloxy)-phenyl]-propionic acid methyl ester

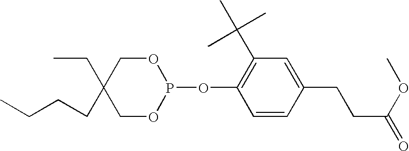

To a solution of 32 g (0.2 mole) 2-ethyl-2-butyl-1,3-propandiol in 700 mL of toluene is added dropwise at 60° C., 18 mL (0.2 mole) of phosphorus trichloride. After 90 min., P³¹ NMR shows, that the PCl₃ (signal at 220 ppm) is fully reacted and a new product is formed (signal at 150 ppm). The temperature is then raised to 80° C. Now a solution of 47.3 g (0.2 mole) 3-(3-tert-butyl-4-hydroxy-phenyl)-propionic acid methyl ester and 200 mL of triethylamine in 300 mL toluene is added dropwise (30 min.). The suspension is stirred for 2.5 hr. After 2 h the P³¹ NMR shows that the educt (signal at 150 ppm) is fully reacted. After filtration and removal of the toluene (rotary evaporator) the product is isolated. Yield: 80 g (0.188 mole=94% of theory). The title compound is a crude light yellow oil, molecular weight 424.52 (C₂₃H₃₇O₅P), P³¹ NMR (400 MHz, CDCl₃, reference is PCl₃ (219 ppm), window −230 to +230 ppm) signals at: 118 ppm (major peak). Total reaction time: 4 h. Filtration through a neutral alumina column provides a mobile colorless liquid.

| | Calculated | Found |
|---|---|---|
| % P | 7.3 | 7.23 |

### Compound Example 4

### Preparation of 4-[3-tert-butyl-4-(5-butyl-5-ethyl-[1,3,2]dioxaphosphinan-2-yloxy)-phenyl]-butyric acid 6-{3-[3-tert-butyl-4-(5-butyl-5-ethyl-[1,3,2]dioxaphosphinan-2-yloxy)-phenyl]-propionyloxy}-hexyl ester

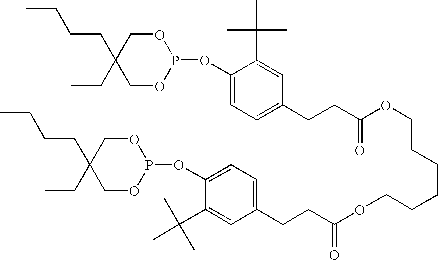

To a solution of 33 g (0.21 mole) 2-butyl-2-ethyl-1,3-propandiol in 700 mL of toluene is added dropwise at 60° C. 18 mL (0.21 mole) of phosphorus trichloride. After 1 h 15 min., the P³¹ NMR shows that the PCl₃ (signal at 220 ppm) is fully reacted and a new product is formed (signal at 150 ppm). The temperature is raised to 80° C. Now a solution of 54.2 g (0.105 mole) 3-(3-tert-butyl-4-hydroxy-phenyl)-propionic acid 6-[3-(3-tert-butyl-4-hydroxy-phenyl)-propionyloxy]-hexyl ester and 200 mL of triethylamine in 500 mL toluene is added dropwise (45 min). The reaction mixture turns into a suspension which is stirred for 2 h 15 min. After 1 h 45 min. the P³¹ NMR shows that the educt (signal at 150 ppm) is fully reacted. After filtration and removal of the toluene (rotary evaporator) the product is isolated. Because thin layer chromatography analytics shows the existence of small amounts of by-products and educt the product is purified over a silica gel column. Yield: 56 g (0.062 mol=59% of theory). The title compound is a colourless oil; molecular weight 903.14 (C₅₀H₈₀O₁₀P₂), P³¹ NMR (400 MHz, CDCl₃, reference is PCl₃ (219 ppm) window is −230 to +230 ppm) signals at: 116 ppm (major peak). Total reaction time: 3 h 30 min.

| | Calculated | Found |
|---|---|---|
| % P | 6.86 | 6.65 |

### Compound Example 5

The following compounds are prepared according to the present methods:

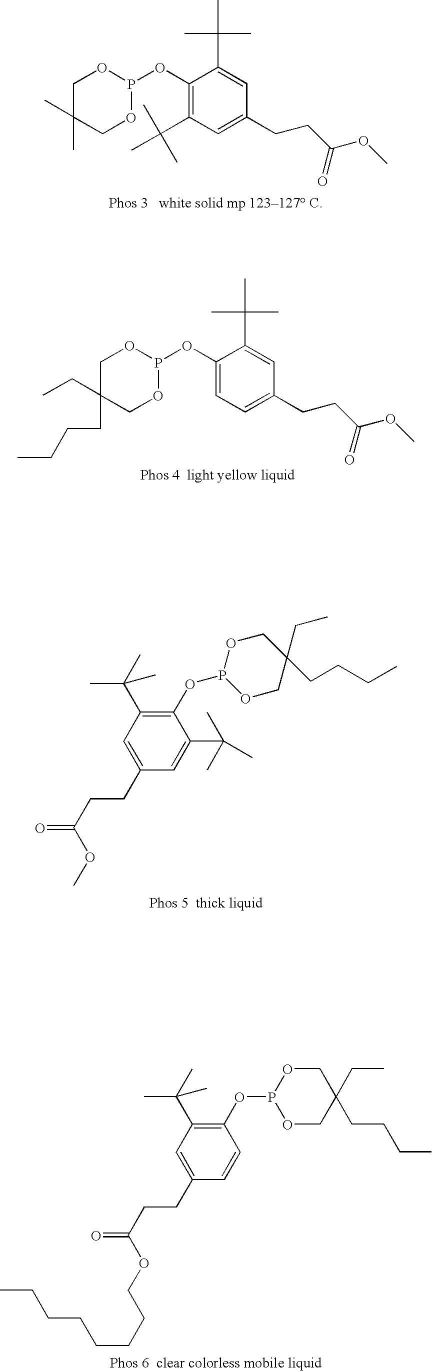

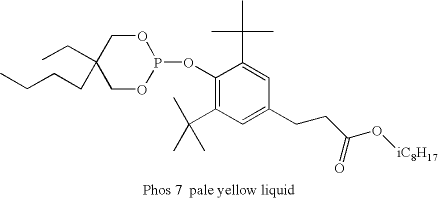

### APPLICATION EXAMPLES

The formulations in the Application Examples employ the following compounds:

AO1 is pentaerythritol tetrakis[3-(3,5-di-tert-butyl-4-hydroxyphenyl)propionate],

AO2 is octadecyl 3-(3,5-di-tert-butyl-4-hydroxyphenyl)propionate,

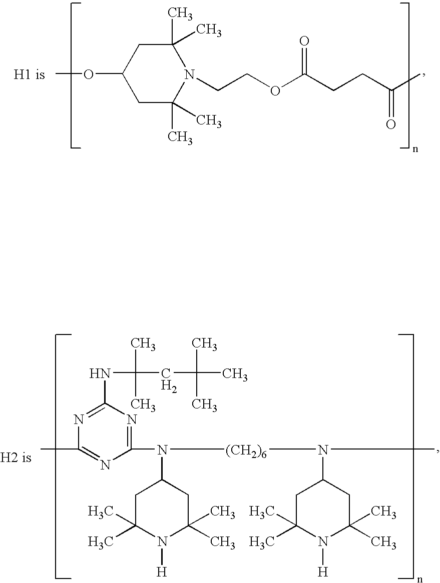

Phos1 is tris(2,4-di-tert-butylphenyl)phosphite

Phos2 is the product of Example 1

Phos3-Phos7 are found above in Compound Example 5

BF1 is Irganox® HP-136, 3-(3,4-dimethylphenyl)-5,7-di-tert-butyl-benzofuran-2-one,

NOH is an N,N-di(alkyl)hydroxylamine produced by the direct oxidation of N,N-di(hydrogenated tallow)amine, prepared in the working Examples of U.S. Pat. No. 5,013,510,

AOx is a di(C₁₆-C₁₈)alkyl methyl amine oxide, CAS# 204933-93-7.

### Application Example 1

A film grade ethylene/butene Zeigler-Natta catalyst based linear low density polyethylene (LL 3001; density=0.918 g/cm³) essentially free of any stabilization additives is dry blended with the base stabilization and the test additives. The base stabilization in this example included 200 ppm of a phenolic antioxidant, Irganox® 1076, and 800 ppm of a polymer processing aid, Dynamar FX-5920A. The phosphite test additives are added on a molar equivalent basis (17 ppm phosphorus). The formulations are initially melt compounded in a twin screw extruder at 190° C. under nitrogen; corresponding to the zero pass extrusion. The resultant extrudate is then multiple pass extruded on a single screw extruder, fitted with a Maddock mixing section, at 260° C. Samples of first, third and fifth pass extrudate are collected for additional testing. Plaques (125 mil) are prepared by compression molding of zero, first, third and fifth pass extrudate at 380° F. with 3 minutes each of low pressure, then high pressure, and then cooling. The specimens are tested for melt flow rate retention (according to ASTM-1238; 190° C./2.16 kg; 21.6 kg), color development during extrusion, and color development during exposure to oxides of nitrogen at 60° C. using 60 mil compression molded plaques (ASTM-1925). The results are shown below. Additives are reported in weight percent based on the polymer.

| | Formula # | | | | | | | |
|---|---|---|---|---|---|---|---|---|
| | None | Phos 1 | Phos 2 | Phos 3 | Phos 4 | Phos 5 | Phos 6 | Phos 7 |
| Phos (ppm) | 0 | 355 | 202 | 233 | 233 | 263 | 287 | 318 |

Melt Flow Rate; 190° C.; 2.16 kg

| | | | | | | | | |
|---|---|---|---|---|---|---|---|---|
| Zero | 1.34 | 1.34 | 1.37 | 1.41 | 1.45 | 1.39 | 1.40 | 1.36 |
| 1st | 1.13 | 1.30 | 1.31 | 1.37 | 1.41 | 1.37 | 1.34 | 1.33 |
| 3rd | 0.97 | 1.02 | 1.17 | 1.25 | 1.28 | 1.19 | 1.31 | 1.30 |
| 5th | 0.84 | 0.89 | 1.12 | 1.12 | 1.19 | 1.10 | 1.13 | 1.17 |

Melt Flow Rate Data; 190° C.; 21.6 kg

| | | | | | | | | |
|---|---|---|---|---|---|---|---|---|
| Zero | 34.09 | 35.06 | 33.84 | 34.38 | 35.45 | 33.97 | 34.43 | 33.70 |
| 1st | 32.84 | 35.14 | 33.94 | 34.13 | 35.20 | 34.53 | 33.57 | 33.88 |
| 3rd | 31.92 | 35.63 | 33.49 | 34.37 | 35.08 | 33.39 | 33.76 | 33.82 |
| 5th | 32.67 | 36.62 | 33.75 | 34.39 | 34.99 | 33.48 | 33.59 | 33.01 |

Melt Flow Ratio; 190° C.; 21.6/2.16 kg

| | | | | | | | | |
|---|---|---|---|---|---|---|---|---|
| Zero | 25.52 | 26.08 | 24.64 | 24.37 | 24.43 | 24.47 | 24.63 | 24.74 |
| 1st | 29.03 | 27.09 | 25.90 | 24.99 | 25.02 | 25.15 | 25.09 | 25.40 |
| 3rd | 32.80 | 34.87 | 28.65 | 27.40 | 27.39 | 28.01 | 25.79 | 26.00 |
| 5th | 38.70 | 41.05 | 30.24 | 30.70 | 29.38 | 30.44 | 29.70 | 28.22 |

As seen in the extrusion pass vs. melt flow rate retention table, the liquid mono-t-butyl-phosphites provide good performance in comparison to a traditional solid phosphite (e.g., Phos 1). Since the phosphorus concentrations are equivalent in each of the comparisons, those skilled in the art should recognize the performance benefit from the liquid cyclic diol based phosphites.

| | Formula # | | | | | | | |
|---|---|---|---|---|---|---|---|---|
| | None | Phos 1 | Phos 2 | Phos 3 | Phos 4 | Phos 5 | Phos 6 | Phos 7 |
| Phos (ppm) | 0 | 355 | 202 | 233 | 233 | 263 | 287 | 318 |

YI Color Data; C Illuminant; 2° Observer

| | | | | | | | | |
|---|---|---|---|---|---|---|---|---|
| Zero | 1.27 | 0.98 | 2.13 | 1.63 | 0.69 | 0.26 | 0.22 | 0.35 |
| 1st | 3.86 | 3.91 | 5.47 | 3.57 | 3.05 | 2.48 | 2.47 | 2.86 |
| 3rd | 6.27 | 7.02 | 6.01 | 4.95 | 5.43 | 3.62 | 5.02 | 3.88 |
| 5th | 7.70 | 9.09 | 7.21 | 6.16 | 6.24 | 4.87 | 6.45 | 5.30 |

As can be seen in this extrusion pass vs. yellowness index color retention table, the liquid mono-t-butyl-phosphites provide good performance in comparison to a traditional solid phosphite (e.g., Phos 1). Again, upon closer inspection, one can see that these liquid mono-t-butyl substituted phosphites also consistently provide better performance in comparison to their di-tert-butyl counterparts. Since the phosphorus concentrations are equivalent in each of the comparisons, those skilled in the art should recognize the performance benefit derived from the liquid cyclic diol based phosphites.

| | Formula # | | | | | | | |
|---|---|---|---|---|---|---|---|---|
| | None | Phos 1 | Phos 2 | Phos 3 | Phos 4 | Phos 5 | Phos 6 | Phos 7 |
| Phos (ppm) | 0 | 355 | 202 | 233 | 233 | 263 | 287 | 318 |

Gas Fade Aging; 60° C.; 1st Pass;

| | | | | | | | | |
|---|---|---|---|---|---|---|---|---|
| 0 Days | 1.58 | 1.56 | 1.62 | 1.47 | 1.50 | 1.39 | 1.36 | 1.42 |
| 7 Days | 4.06 | 3.13 | 4.14 | 2.73 | 2.52 | 2.72 | 4.70 | 3.51 |
| 14 Days | 6.67 | 5.95 | 6.23 | 5.06 | 7.41 | 4.90 | 7.39 | 6.58 |
| 21 Days | 8.79 | 7.21 | 8.30 | 7.29 | 9.28 | 7.55 | 9.94 | 8.44 |
| 28 Days | 10.33 | 7.23 | 9.80 | 8.64 | 10.34 | 9.10 | 11.00 | 9.77 |

As can be seen in this yellowness index color retention during exposure to oxides of nitrogen table, the liquid mono-t-butyl-phosphites provide good performance in comparison to a traditional solid phosphite (e.g., Phos 1). Again, in regard to gas fade discoloration resistance, one can see that these liquid mono-t-butyl substituted phosphites also consistently provide better performance in comparison to their di-tert-butyl counterparts. Since the phosphorus concentrations are equivalent in each of the comparisons, those skilled in the art should recognize the performance benefit derived from the liquid cyclic diol based phosphites.

### Application Example 2

The same experiment as described in Example 1 above is run using a higher concentration of the various phosphites (51 ppm Phosphorus vs. 17 ppm Phosphorus as shown in Example 1).

| | Formula # | | | | | | | |
|---|---|---|---|---|---|---|---|---|
| | None | Phos 1 | Phos 2 | Phos 3 | Phos 4 | Phos 5 | Phos 6 | Phos 7 |
| Phos (ppm) | 0 | 1065 | 606 | 698 | 698 | 790 | 861 | 953 |

Melt Flow Rate; 190° C.; 2.16 kg

| | | | | | | | | |
|---|---|---|---|---|---|---|---|---|
| Zero | 1.34 | 1.36 | 1.36 | 1.37 | 1.35 | 1.35 | 1.41 | 1.40 |
| 1st | 1.13 | 1.36 | 1.37 | 1.37 | 1.37 | 1.37 | 1.38 | 1.38 |
| 3rd | 0.97 | 1.32 | 1.28 | 1.35 | 1.32 | 1.38 | 1.36 | 1.38 |
| 5th | 0.84 | 1.25 | 1.16 | 1.31 | 1.27 | 1.34 | 1.25 | 1.36 |

Melt Flow Rate Data; 190° C.; 21.6 kg

| | | | | | | | | |
|---|---|---|---|---|---|---|---|---|
| Zero | 34.09 | 33.53 | 33.64 | 33.96 | 33.40 | 33.60 | 34.66 | 34.44 |
| 1st | 32.84 | 33.41 | 33.85 | 34.03 | 33.70 | 33.60 | 34.39 | 34.31 |
| 3rd | 31.92 | 33.62 | 34.37 | 34.61 | 33.90 | 34.44 | 34.71 | 34.82 |
| 5th | 32.67 | 32.94 | 33.89 | 34.98 | 34.20 | 34.83 | 34.32 | 35.43 |

Melt Flow Ratio; 190° C.; 21.6/2.16 kg

| | | | | | | | | |
|---|---|---|---|---|---|---|---|---|
| Zero | 25.52 | 24.71 | 24.79 | 24.72 | 24.83 | 24.82 | 24.67 | 24.62 |
| 1st | 29.03 | 24.66 | 24.78 | 24.87 | 24.69 | 24.60 | 24.92 | 24.82 |
| 3rd | 32.80 | 25.43 | 26.79 | 25.66 | 25.62 | 24.88 | 25.62 | 25.31 |
| 5th | 38.70 | 26.31 | 29.24 | 26.68 | 26.95 | 25.99 | 27.52 | 26.07 |

As seen in the extrusion pass vs. melt flow rate retention table, the liquid mono-t-butyl-phosphites provide good performance in comparison to a traditional solid phosphite (e.g., Phos 1). Since the phosphorus concentrations are equivalent in each of the comparisons, those skilled in the art should recognize the performance benefit from the liquid mono-t-butyl substituted phosphites.

| | Formula # | | | | | | | |
|---|---|---|---|---|---|---|---|---|
| | None | Phos 1 | Phos 2 | Phos 3 | Phos 4 | Phos 5 | Phos 6 | Phos 7 |
| Phos (ppm) | 0 | 1065 | 606 | 698 | 698 | 790 | 861 | 953 |

YI Color Data; C Illuminant; 2° Observer

| | | | | | | | | |
|---|---|---|---|---|---|---|---|---|
| Zero | 1.27 | 1.25 | 1.26 | 0.36 | 0.60 | 0.29 | 0.45 | −0.15 |
| 1st | 3.86 | 3.36 | 3.20 | 1.73 | 2.02 | 1.73 | 1.47 | 1.51 |
| 3rd | 6.27 | 5.52 | 6.57 | 4.58 | 5.09 | 4.71 | 3.93 | 4.49 |
| 5th | 7.70 | 7.37 | 7.99 | 7.19 | 6.40 | 5.83 | 4.82 | 8.47 |

As can be seen in this extrusion pass vs. yellowness index color retention table, the liquid mono-t-butyl-phosphites provide good performance in comparison to a traditional solid phosphite (e.g., Phos 1). Again, upon closer inspection, one can see that these liquid mono-t-butyl substituted phosphites also consistently provide better performance in comparison to their di-tert-butyl counterparts. Since the phosphorus concentrations are equivalent in each of the comparisons, those skilled in the art should recognize the performance benefit derived from the liquid mono-t-butyl substituted phosphites.

| | Formula # | | | | | | | |
|---|---|---|---|---|---|---|---|---|
| | None | Phos 1 | Phos 2 | Phos 3 | Phos 4 | Phos 5 | Phos 6 | Phos 7 |
| Phos (ppm) | 0 | 1065 | 606 | 698 | 698 | 790 | 861 | 953 |

Gas Fade Aging; 60° C.; 1st Pass;

| | | | | | | | | |
|---|---|---|---|---|---|---|---|---|
| 0 Days | 1.58 | 1.58 | 1.48 | 1.36 | 1.45 | 1.44 | 1.33 | 1.34 |
| 7 Days | 4.06 | 2.91 | 2.71 | 1.61 | 2.52 | 1.69 | 2.96 | 1.87 |
| 14 Days | 6.67 | 3.77 | 3.94 | 2.03 | 3.43 | 2.61 | 4.65 | 3.16 |
| 21 Days | 8.79 | 4.15 | 6.03 | 4.07 | 4.74 | 5.85 | 6.17 | 6.69 |
| 28 Days | 10.33 | 4.51 | 7.55 | 6.97 | 6.48 | 8.14 | 7.63 | 9.38 |

As can be seen in this yellowness index color retention during exposure to oxides of nitrogen table, the liquid mono-t-butyl-phosphites provide good performance in comparison to a traditional solid phosphite (e.g., Phos 1). Again, in regard to gas fade discoloration resistance, one can see that these liquid mono-t-butyl substituted phosphites also consistently provide better performance in comparison to their di-tert-butyl counterparts. Since the phosphorus concentrations are equivalent in each of the comparisons, those skilled in the art should recognize the performance benefit derived from the liquid mono-t-butyl substituted phosphites.

Overall, similar trends are observed, suggesting that there is not a unique concentration dependence for the performance measures described in Example 1.

### Application Example 3

Using a similar procedure as described in Example 1, a film grade ethylene/butene metallocene catalyst based linear low density polyethylene (LL 1018; density=0.918 g/cm³), essentially free of any stabilization additives, is dry blended with the base stabilization and the various test additives. The base stabilization in this example included 500 ppm of a phenolic antioxidant, Irganox® 1076, and 800 ppm of a polymer processing aid, Dynamar FX-5920A. The phosphite test additives are added on a molar equivalent basis (42.5 ppm phosphorus).

| | Formula # | | | | | | | |
|---|---|---|---|---|---|---|---|---|
| | None | Phos 1 | Phos 2 | Phos 3 | Phos 4 | Phos 5 | Phos 6 | Phos 7 |
| Phos (ppm) | 0 | 888 | 505 | 582 | 582 | 659 | 718 | 794 |

Melt Flow Rate; 190° C.; 2.16 kg

| | | | | | | | | |
|---|---|---|---|---|---|---|---|---|
| Zero | 1.06 | 1.06 | 1.09 | 1.11 | 1.09 | 1.08 | 1.08 | 1.09 |
| 1st | 0.98 | 1.06 | 1.08 | 1.11 | 1.09 | 1.08 | 1.07 | 1.08 |
| 3rd | 0.86 | 1.05 | 1.07 | 1.09 | 1.06 | 1.05 | 1.04 | 1.07 |
| 5th | 0.80 | 1.03 | 1.07 | 1.12 | 1.05 | 1.01 | 0.98 | 1.04 |

Melt Flow Rate Data; 190° C.; 21.6 kg

| | | | | | | | | |
|---|---|---|---|---|---|---|---|---|
| Zero | 17.91 | 17.56 | 17.96 | 18.05 | 18.11 | 17.92 | 17.77 | 17.91 |
| 1st | 17.70 | 17.56 | 18.24 | 18.14 | 18.39 | 17.86 | 17.95 | 18.03 |
| 3^{rd} | 17.35 | 17.81 | 18.25 | 18.28 | 18.39 | 18.15 | 17.87 | 18.30 |
| 5th | 17.08 | 17.88 | 18.39 | 18.69 | 18.57 | 18.00 | 17.87 | 18.38 |

Melt Flow Ratio; 190° C.; 21.6/2.16 kg

| | | | | | | | | |
|---|---|---|---|---|---|---|---|---|
| Zero | 16.86 | 16.51 | 16.49 | 16.32 | 16.65 | 16.54 | 16.41 | 16.47 |
| 1st | 17.77 | 16.56 | 16.93 | 16.33 | 16.81 | 16.62 | 16.74 | 16.77 |
| 3^{rd} | 19.79 | 17.03 | 17.11 | 16.84 | 17.31 | 17.25 | 17.15 | 17.04 |
| 5th | 21.32 | 17.34 | 17.25 | 16.68 | 17.62 | 17.89 | 18.22 | 17.67 |

As seen in the extrusion pass vs. melt flow rate retention table, the liquid cyclic diol based phosphites provide good performance in comparison to a traditional solid phosphite (e.g., Phos 1). Since the phosphorus concentrations are equivalent in each of the comparisons, those skilled in the art should recognize the performance benefit from these liquid cyclic diol based phosphites.

| | Formula # | | | | | | | |
|---|---|---|---|---|---|---|---|---|
| | None | Phos 1 | Phos 2 | Phos 3 | Phos 4 | Phos 5 | Phos 6 | Phos 7 |
| Phos (ppm) | 0 | 888 | 505 | 582 | 582 | 659 | 718 | 794 |

YI Color Data; C Illuminant; 2° Observer

| | | | | | | | | |
|---|---|---|---|---|---|---|---|---|
| Zero | 5.09 | 1.64 | 2.15 | 2.58 | 2.81 | 2.49 | 2.18 | 2.38 |
| 1st | 7.00 | 4.30 | 3.78 | 4.23 | 5.45 | 3.89 | 3.50 | 3.75 |
| 3rd | 9.45 | 7.65 | 6.83 | 7.67 | 8.23 | 6.78 | 6.70 | 7.48 |
| 5th | 12.00 | 10.20 | 9.80 | 10.00 | 9.50 | 8.60 | 8.40 | 10.00 |

As can be seen in this extrusion pass vs. yellowness index color retention table, the liquid cyclic diol based phosphites provide good performance in comparison to a traditional solid phosphite (e.g., Phos 1). Again, upon closer inspection, one can see that in most cases the liquid mono-t-butyl substituted phosphites provide better performance in comparison to their di-tert-butyl counterparts. Since the phosphorus concentrations are equivalent in each of the comparisons, those skilled in the art should recognize the performance benefit derived from the liquid mono-t-butyl substituted phosphites.

| | Formula # | | | | | | | |
|---|---|---|---|---|---|---|---|---|
| | None | Phos 1 | Phos 2 | Phos 3 | Phos 4 | Phos 5 | Phos 6 | Phos 7 |
| Phos (ppm) | 0 | 888 | 505 | 582 | 582 | 659 | 718 | 794 |

Gas Fade Aging; 60° C.; 1st Pass;

| | | | | | | | | |
|---|---|---|---|---|---|---|---|---|
| 0 Days | 2.36 | 1.51 | 1.67 | 1.75 | 1.76 | 1.76 | 1.72 | 1.64 |
| 7 Days | 4.87 | 2.90 | 3.70 | 2.16 | 2.81 | 2.06 | 2.48 | 2.04 |
| 14 Days | 7.51 | 3.73 | 4.40 | 2.48 | 3.45 | 2.40 | 3.09 | 2.45 |
| 21 Days | 10.59 | 4.33 | 6.58 | 3.53 | 4.18 | 3.17 | 3.81 | 3.61 |
| 28 Days | 12.39 | 4.65 | 9.52 | 6.34 | 5.08 | 4.97 | 4.75 | 5.42 |

As can be seen in this yellowness index color retention during exposure to oxides of nitrogen table, the liquid cyclic diol based phosphites provide comparable performance in comparison to a traditional solid phosphite (e.g., Phos 1). Since the phosphorus concentrations are equivalent in each of the comparisons, those skilled in the art should recognize the performance benefit derived from the liquid cyclic diol based phosphites.

### Application Example 4

The same experimental protocol as described above in Example 3 is run using a higher concentration of the various phosphites (85 ppm Phosphorus vs. 42.5 ppm Phosphorus).

| | Formula # | | | | | | | |
|---|---|---|---|---|---|---|---|---|
| | None | Phos 1 | Phos 2 | Phos 3 | Phos 4 | Phos 5 | Phos 6 | Phos 7 |
| Phos (ppm) | 0 | 1775 | 1010 | 1164 | 1164 | 1317 | 1435 | 1589 |

Melt Flow Rate; 190° C.; 2.16 kg

| | | | | | | | | |
|---|---|---|---|---|---|---|---|---|
| Zero | 1.34 | 1.36 | 1.36 | 1.37 | 1.35 | 1.35 | 1.41 | 1.40 |
| 1st | 1.13 | 1.36 | 1.37 | 1.37 | 1.37 | 1.37 | 1.38 | 1.38 |
| 3rd | 0.97 | 1.32 | 1.28 | 1.35 | 1.32 | 1.38 | 1.36 | 1.38 |
| 5th | 0.84 | 1.25 | 1.16 | 1.31 | 1.27 | 1.34 | 1.25 | 1.36 |

Melt Flow Rate Data; 190° C.; 21.6 kg

| | | | | | | | | |
|---|---|---|---|---|---|---|---|---|
| Zero | 34.09 | 33.53 | 33.64 | 33.96 | 33.40 | 33.60 | 34.66 | 34.44 |
| 1st | 32.84 | 33.41 | 33.85 | 34.03 | 33.70 | 33.60 | 34.39 | 34.31 |
| 3rd | 31.92 | 33.62 | 34.37 | 34.61 | 33.90 | 34.44 | 34.71 | 34.82 |
| 5th | 32.67 | 32.94 | 33.89 | 34.98 | 34.20 | 34.83 | 34.32 | 35.43 |

Melt Flow Ratio; 190° C.; 21.6/2.16 kg

| | | | | | | | | |
|---|---|---|---|---|---|---|---|---|
| Zero | 25.52 | 24.71 | 24.79 | 24.72 | 24.83 | 24.82 | 24.67 | 24.62 |
| 1st | 29.03 | 24.66 | 24.78 | 24.87 | 24.69 | 24.60 | 24.92 | 24.82 |
| 3rd | 32.80 | 25.43 | 26.79 | 25.66 | 25.62 | 24.88 | 25.62 | 25.31 |
| 5th | 38.70 | 26.31 | 29.24 | 26.68 | 26.95 | 25.99 | 27.52 | 26.07 |

As seen in the extrusion pass vs. melt flow rate retention table, the liquid cyclic diol based phosphites provide good performance in comparison to a traditional solid phosphite (e.g., Phos 1). Since the phosphorus concentrations are equivalent in each of the comparisons, those skilled in the art should recognize the performance benefit from the liquid mono-t-butyl substituted phosphites.

| | Formula # | | | | | | | |
|---|---|---|---|---|---|---|---|---|
| | None | Phos 1 | Phos 2 | Phos 3 | Phos 4 | Phos 5 | Phos 6 | Phos 7 |
| Phos (ppm) | 0 | 1775 | 1010 | 1164 | 1164 | 1317 | 1435 | 1589 |

YI Color Data; C Illuminant; 2° Observer

| | | | | | | | | |
|---|---|---|---|---|---|---|---|---|
| Zero | 1.27 | 1.25 | 1.26 | 0.36 | 0.60 | 0.29 | 0.45 | −0.15 |
| 1st | 3.86 | 3.36 | 3.20 | 1.73 | 2.02 | 1.73 | 1.47 | 1.51 |
| 3rd | 6.27 | 5.52 | 6.57 | 4.58 | 5.09 | 4.71 | 3.93 | 4.49 |
| 5th | 7.70 | 7.37 | 7.99 | 7.19 | 6.40 | 5.83 | 4.82 | 8.47 |

As can be seen in this extrusion pass vs. yellowness index color retention table, the liquid cyclic diol based phosphites provide good performance in comparison to a traditional solid phosphite (e.g., Phos 1). Upon closer inspection, one can see that these liquid cyclic diol based mono-t-butyl substituted phosphites also consistently provide better performance in comparison to their di-tert-butyl counterparts. Since the phosphorus concentrations are equivalent in each of the comparisons, those skilled in the art should recognize the performance benefit derived from the liquid mono-t-butyl substituted phosphites.

| | Formula # | | | | | | | |
|---|---|---|---|---|---|---|---|---|
| | | Phos | Phos | Phos | Phos | Phos | Phos | Phos |
| | None | 1 | 2 | 3 | 4 | 5 | 6 | 7 |
| Phos (ppm) | 0 | 1775 | 1010 | 1164 | 1164 | 1317 | 1435 | 1589 |

Gas Fade Aging; 60° C.; 1st Pass;

| | | | | | | | | |
|---|---|---|---|---|---|---|---|---|
| 0 Days | 1.58 | 1.58 | 1.48 | 1.36 | 1.45 | 1.44 | 1.33 | 1.34 |
| 7 Days | 4.06 | 2.91 | 2.71 | 1.61 | 2.52 | 1.69 | 2.96 | 1.87 |
| 14 Days | 6.67 | 3.77 | 3.94 | 2.03 | 3.43 | 2.61 | 4.65 | 3.16 |
| 21 Days | 8.79 | 4.15 | 6.03 | 4.07 | 4.74 | 5.85 | 6.17 | 6.69 |
| 28 Days | 10.33 | 4.51 | 7.55 | 6.97 | 6.48 | 8.14 | 7.63 | 9.38 |

As can be seen in this yellowness index color retention during exposure to oxides of nitrogen table, the liquid mono-t-butyl-phosphites provide comparable performance in comparison to a traditional solid phosphite (e.g., Phos 1). Since the phosphorus concentrations are equivalent in each of the comparisons, those skilled in the art should recognize the performance benefit derived from the liquid mono-t-butyl substituted phosphites.

Overall, similar trends are observed in Example 4, suggesting that there is not a unique concentration dependence for the performance measures described in Example 3.

Viscosity

Visosities of phosphites are measured on a AR-2000N cone/plate rheometer: 40 mm 20 steel cone with peltier plate, constant 10 Pa shear stress, 2° C./min. temperature ramp from 0° C. to 100° C.

| | Viscosity (mPa · s) | | | | | |
|---|---|---|---|---|---|---|
| Sample ID | 2° C. | 20° C. | 40° C. | 60° C. | 80° C. | 100° C. |
| (a) | 140,000 | 10,800 | 1250 | 254 | 79.1 | 33.5 |
| (b) | 1,240,000 | 22,900 | 1191 | 162 | 41.5 | 16.1 |
| Phos2 | 2,468 | 307 | 66.6 | 24.0 | 12.0 | 7.4 |
| (Compound | | | | | | |
| Ex 1) | | | | | | |
| Compound | 4,663 | 648 | 130 | 42.8 | 19.4 | 11.0 |
| Ex 2 | | | | | | |
| Compound | 6,131 | 724 | 134 | 41.5 | 18.4 | 10.2 |
| Ex3 | | | | | | |

Phosphites of the present invention are much less viscous than phosphites not of the present invention (a, b). The lower viscosity allows for greater ease of handling.

(a) is tris-nonylphenylphosphite

(b) is

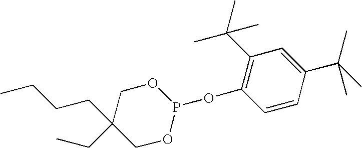

What is claimed is:

1. A compound of the formula I or II 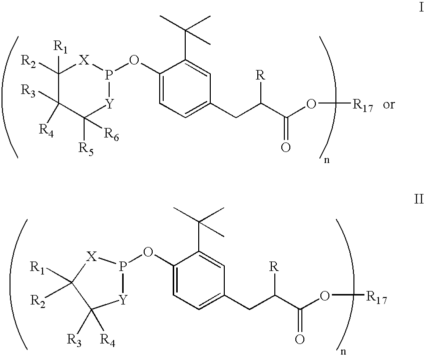
wherein
R is hydrogen or methyl,
R₁, R₂, R₃, R₄, R₅ and R₆ are independently hydrogen, straight or branched chain alkyl of 1 to 24 carbon atoms, cycloalkyl of 5 to 12 carbon atoms, phenylalkyl of 7 to 9 carbon atoms, said phenylalkyl substituted on the phenyl ring by one or two straight or branched chain alkyl of 1 to 12 carbon atoms, aryl of 6 to 10 carbon atoms or said aryl substituted by one or two straight or branched chain alkyl of 1 to 12 carbon atoms, or
R₁ and R₂ together, or R₃ and R₄ together, or R₅ and R₆ together, or one of R₁ or R₂ together with one of R₃ or R₄, or one of R₃ or R₄ together with one of R₅ or R₆, with the ring carbon atoms to which they are attached form a cycloalkyl ring of 5 or 6 carbon atoms,
X and Y are independently —O—, >N—R₂₂ or —S—, 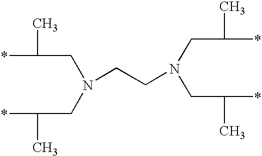
where * denotes the point of attachment,
which cyclic phosphites are in the liquid state at 25° C. and 1 atm of pressure.

2. A compound of the formula I according to claim 1.

3. A compound of the formula II according to claim 1.

4. A compound of the formula I according to claim 1,
where
X and Y are —O—,
n is 1,
R₁₇ is straight or branched chain alkyl of 1 to 18 carbon atoms,
R₁, R₂, R₃, R₄, R₅ and R₆ are independently hydrogen or straight or branched chain alkyl of 1 to 20 carbon atoms and
R is hydrogen.

5. A compound of the formula I according to claim 1,
where
R₂₂ is straight or branched chain alkyl of 1 to 18 carbon atoms,
n is an integer from 1 to 4,
if n=1
R₁₇ is hydrogen, straight or branched chain alkyl of 1 to 24 carbon atoms, cycloalkyl of 5 to 12 carbon atoms, straight or branched chain alkenyl of 2 to 18 carbon atoms, or R₁₇ is —CH₂CH₂-T₃-R₁₉ or —(CᵣH₂ᵣO)ₚ—CᵣH₂ᵣOR₁₉ where T₃ is —O—, —S— or >N—R₂, R₂₂ is straight or branched chain alkyl of 1 to 18 carbon atoms, R₁₉ is straight or branched chain alkyl of 1 to 18 carbon atoms, p is an integer from 1 to 20 and r is 2 or 3,
if n=2
R₁₇ is a divalent radical —CₜH₂ₜ— or —(CᵣH₂ᵣO)ₚ—CᵣH₂ᵣ— where t is an integer of from 2 to 16, p is an integer from 1 to 20 and r is 2 or 3, or R₁₇ is a divalent radical —CH₂CH₂-T₃-CH₂CH₂— or —CH₂—CH═CH—CH₂— where T₃ is —O—, —S— or >N—R₂₂ where R₂₂ is straight or branched chain alkyl of 1 to 18 carbon atoms,
if n=3
R₁₇ is a trivalent radical 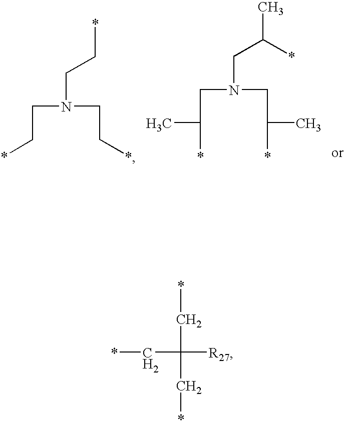
where R₂₇ is hydrogen or straight or branched chain alkyl of 1 to 4 carbon atoms and where * denotes the point of attachment and
if n=4
R₁₇ is an alkanetetrayl of 4 to 12 carbon atoms or is
X and Y are —,
n is 1,
R₁₇ is straight or branched chain alkyl of 1 to 18 carbon atoms,
R₁, R₂, R₅ and R₆ are independently hydrogen or methyl and R₃ and R₄ are independently methyl, ethyl, i-propyl, n-propyl, n-butyl, sec-butyl or t-butyl and
R is hydrogen.

6. A compound of the formula I according to claim 1,
where
X and Y are —O—,
n is 2,
R₁₇ is —CₜH₂ₜ— or —CH₂CH₂-T₃-CH₂CH₂— where T₃ is —S— or >N—R₂₂ where R₂₂ is straight or branched chain alkyl of 1 to 12 carbon atoms and t is an integer of from 2 to 6,
R₁, R₂, R₅ and R₆ are independently hydrogen or methyl and R₃ and R₄ are independently methyl, ethyl, i-propyl, n-propyl, n-butyl, sec-butyl or t-butyl and
R is hydrogen.

7. A compound of the formula I according to claim 1 selected from the group consisting of

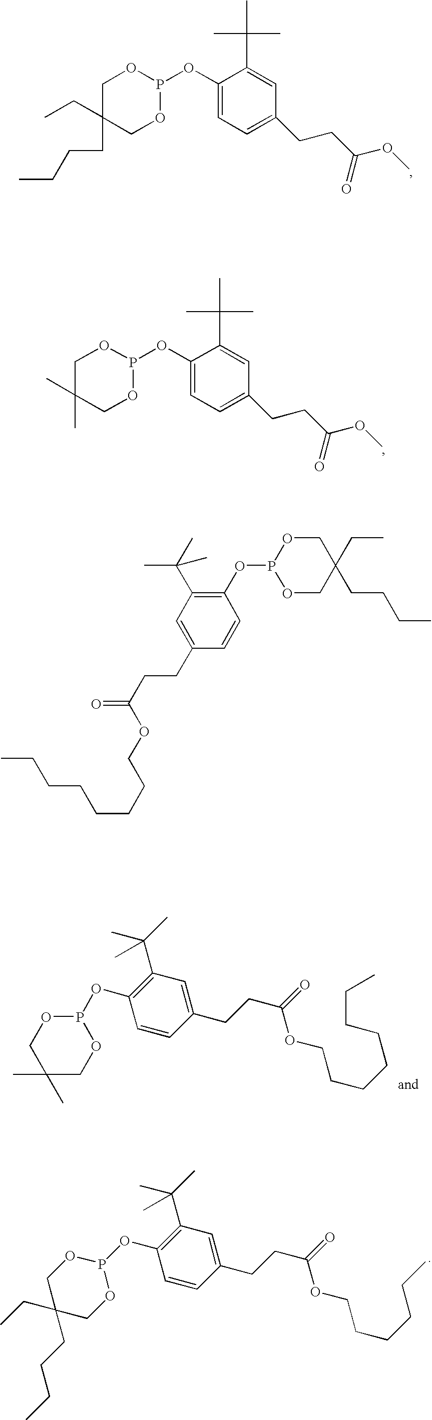

8. A compound of the formula I or II according to claim 1 where the compound exhibits a viscosity of less than about 1000 mPa·sec at 20° C. or less than about 150 mPa·s at 40° C. as measured on a cone/plate rheometer: 40 mm 2° steel cone with peltier plate, constant 10 Pa shear stress, 2° C./min temperature ramp from 0° C. to 100° C.

9. A compound of the formula I or II according to claim 1 where the compound exhibits a viscosity of less than about 750 mPa·sec at 20° C. or less than about 135 mPa·s at 40° C. as measured on a cone/plate rheometer: 40 mm 2° steel cone with peltier plate, constant 10 Pa shear stress, 2° C./min temperature ramp from 0° C. to 100° C.

10. A process for stabilizing a polyolefin against the deleterious effects of melt processing, heat aging and exposure to combustion products of natural gas, which process comprises
incorporating into or applying to said polyolefin
an effective stabilizing amount of one or more compounds of the formula I or II according to claim 1.

11. A process according to claim 10 comprising incorporating or applying one or more compounds of the formula I.

12. A process according to claim 10 comprising incorporating or applying one or more compounds of the formula II.

13. A process according to claim 10 where the compounds of formula I or II are incorporated or applied at a level of from about 0.01% to about 5% by weight, based on the weight of the polyolefin.

14. A process according to claim 10 where the compounds of formula I or II are incorporated or applied at a level of less than about 3% by weight, based on the weight of the polyolefin.

15. A process according to claim 10 comprising incorporating or applying a further stabilizer selected from the group consisting of hindered phenolic antioxidants, hydroxylamines, benzofuranones, other organic phosphorus stabilizers, sterically hindered amine light stabilizers and hydroxyphenylbenzotriazole, tris-aryl-s-triazine or hydroxyphenylbenzophenone ultraviolet light stabilizers.

16. A process according to claim 10 where the polyolefin is polyethylene.

17. A process according to claim 10 where the polyolefin is low density polyethylene.

18. A polyolefin composition stabilized against the deleterious effects of melt processing, heat aging and exposure to combustion products of natural gas, which composition comprises
a polyolefin and
an effective stabilizing amount of
one or more compounds of the formula I or II according to claim 1.
